(19) United States
(12) Patent Application Publication
(10) Pub. No.: US 2026/0110438 A1
(43) Pub. Date: Apr. 23, 2026

(54) OPERATING DEVICE FOR A HOUSEHOLD APPLIANCE

(71) Applicant: BORA - Vertriebs GmbH & Co KG, NIEDERNDORF (AT)

(72) Inventors: Bernd BICHLER, Niederndorf (AT); Helmut PRASCHBERGER, Niederndorf (AT); Simon ENDRES, Niederndorf (AT); Christof DESSL, Niederndorf (AT); Gregor SCHNEIDER, Niederndorf (AT)

(21) Appl. No.: 19/361,578

(22) Filed: Oct. 17, 2025

(30) Foreign Application Priority Data
Oct. 17, 2024 (DE) 10 2024 210 083.8

(51) Int. Cl. F24C 7/08; G05G 9/00

(52) U.S. Cl. CPC F24C 7/086; G05G 9/00

(57) ABSTRACT

An operating device (3) for a household appliance (1, 2) has an operating element (6), and a display device (8), wherein the operating element (6) can be displaced in such a way that the display device (8) is concealed in a first displacement position and the display device (8) is exposed in the second displacement position.

The content of German patent application DE 10 2024 210 083.8 is incorporated herein by reference.

The invention relates to an operating device for a household appliance. The invention also relates to a hob, a combined appliance and an extractor having such an operating device.

Household appliances are usually operated via touch-sensitive controls (so-called touch panels) or by means of operating knobs.

Operating knobs for operating a hob are disclosed, for example in DE 10 2020 207 162 A1 and DE 20 2009 009 727 U1.

It is an object of the present invention to improve an operating device for a household appliance.

This object is achieved by an operating device according to the present invention.

According to one aspect, the operating device can have an operating element and a display device. The operating element can in particular be displaced in such a way that the display device is concealed in a first displacement position, also referred to as the off position. A concealed display device is in particular not exposed. The display device can in particular be concealed by the operating element in the off position of the operating element. The display device can thus be protected by the operating element. This is not a mandatory feature. This aspect can be implemented or not implemented independently of the other features of the invention.

The display device is in particular invisible in the first displacement position of the operating element, in particular from a typical line of site for operating the household appliance, in particular at an angle from the front and/or from at least one side and/or from below. In the first displacement position of the operating element, a normal to the display device passes in particular through the operating element. In the first displacement position of the operating element, in particular all normals to the display device can run through the operating element.

The display device can be exposed in a second displacement position of the operating element. An exposed display device is in particular not concealed. The display device is in particular visible in the second displacement position of the operating element, in particular from a typical line of site for operating the household appliance, in particular at an angle from the front. In the second displacement position of the operating element, a normal to the display device does not in particular pass through the operating element. In the second displacement position of the operating element, in particular none of the normal to the display device passes through the operating element. An exposed device may in particular also be understood as the provision of a functionality. An exposed devise is also referred to as an enabled device. In an exposed position, the device can in particular enable a certain function, in particular adjustability.

In the second displacement position of the operating element, in particular at least one function of the household appliance can be controlled or adjusted by means of the operating element.

The travel between the off position and the second displacement position is, for example, in the range of 10 mm to 30 mm and/or in the range of 10° to 90°, in particular 10° to 45°.

The displacement from the first displacement position, the off position, to the second displacement position is also referred to as a release movement.

According to one aspect, the operating element can be displaced in such a way that it enables the operation of the household appliance with a release movement.

The operating element can cover the display device and thus protect it in particular in the off position and release it in a second displacement position in the switched-on state.

According to one aspect, the operating device can have a display device which remains stationary when the operating element is actuated.

This enables a particularly robust design and arrangement of the display device. In addition, the display device can be designed and/or arranged to be particularly ergonomic.

This feature is independent of the other features of the invention.

However, the operating device is in particular not necessarily an operating knob, in particular a rotary knob.

One aspect of the invention provides that the operating element can be displaced in such a way that it enables the operation of the household appliance with a first displacement movement.

This aspect is not a necessary feature of the invention.

The first displacement movement can be the release movement.

The travel of the release movement is, for example, in the range of 10 mm to 30 mm and/or in the range of 10° to 90°, in particular 10° to 45°.

The operating element can be displaced in particular electrically, mechanically, in particular manually, or magnetically.

The release movement can be a linear movement, a movement along a helical line or a tilting motion.

The release movement can be a guided movement. The displacement path can in particular be determined by a track, in particular a slotted guide.

The release movement can serve to unlock the operating device. It can, for example, serve as a child lock.

The household appliance can in particular be a hob, an extractor, a hob with an integrated extractor, an oven, a microwave, a dishwasher, a coffee machine, a kettle, a pasta boiler, a steamer, an air fryer, a table griller/teppan or a fryer. This list is neither limiting nor exhaustive.

The operating device has an attachment device for attaching the operating device to a kitchen unit. For details of the attachment device, reference is made to DE 10 2020 207 162 A1 and DE 10 2024 206 141.7, which are hereby fully incorporated into the present application.

The operating device can in particular be integrated in a front panel of a kitchen base cabinet or tall kitchen cabinet or drawer. Alternatives are possible. The operating device can also be arranged in a worktop, a wall or another flat structure.

According to one aspect, the operating device can have different operating levels, in particular different hierarchical operating levels. The operating device can in particular enable a hierarchical operating concept.

An operating level is understood as a selection of different settings.

Different operating levels enable menu-guided control and/or operation of the appliance.

An operating level can in particular also be specified mechanically. It can correspond to a displacement position, in particular in the direction perpendicular to an axis of rotation about which the operating element can be rotated.

Different operating levels can in particular be achieved by pulling out and/or pushing in the operating element.

However, a mechanical displacement, in particular a horizontal displacement, in particular pulling out or pushing in the operating element does not necessarily need to be provided to switch between different operating levels. Switching between different operating levels can also be achieved via a touch function and/or via tapping, in particular spring-return tapping, for example clicking or double-clicking the operating element or part thereof. In general, it is possible to switch between different operating levels by means of the operating element, in particular by actuating the operating element.

On one operating level, a power level setting or a temperature level setting is possible, for example. On another operating level, a selection of the kitchen appliance to be operated, for example a selection between a hob, in particular different cooking zones, and an extractor is possible, for example. On another operating level, system settings or other settings are possible, for example.

According to one aspect, the operating element can be displaced in such a way that it is possible to switch between different operating levels by means of a displacement movement.

This feature is not mandatory.

The displacement movement for switching between different operating levels is also referred to as the switch displacement movement.

The operating device can have a lighting device.

The lighting device can be coupled to the displacement position of the operating element. It can in particular be activated differently depending on the displacement position of the operating element. Different operating levels can in particular be displayed by light of different colours.

This enables particularly intuitive operation.

The lighting device can in particular have different LEDs or a controllable LED.

It can be provided that at least part of the display device, in particular a visible portion of the display device, in particular the entire visible region of the display device, moves with the operating element when it is displaced.

It can in particular be provided that the display device moves with the operating element when it is pulled out.

According to one aspect, a function of the household appliance can be controlled or adjusted by means of actuating the operating element. A displacement movement of the operating element can be used to actuate the operating element. An input via a touch-sensitive sensor can also be used to actuate the operating element. Combinations are also possible.

The displacement movement for actuating the operating element can in particular have a movement component different from the release movement. This is not mandatory.

In particular a rotary displacement movement, in particular a rotational movement, can be used to control or adjust the function of the household appliance. It is also possible to control or adjust a function of the household appliance through frontal and/or lateral pressure on the operating element and/or by an axial and/or lateral displacement of the operating element and/or by tilting the operating element.

This enables very flexible functionality of the operating device.

According to another aspect, the operating element can have different displacement positions, wherein different functions of the household appliance can be controlled or adjusted in different displacement positions by means of the operating element.

This means in particular that the operating element has a first displacement position and at least one second displacement position, different from the first, wherein in the first displacement position, at least one first function of the household appliance can be controlled or adjusted, and wherein in the second displacement position, at least one second function of the household appliance, different from the first function, can be controlled or adjusted.

The operating element can in particular have a first displacement position and at least one second displacement position, different from the first, wherein in at least one of the displacement positions, at least one function of the household appliance can be controlled or adjusted, which is not controlled or adjusted in the other displacement position.

The different displacement positions can correspond to different operating levels.

The operating element can in particular have a first displacement position and at least one second displacement position, different from the first, wherein both in the first displacement position and in the second displacement position, in particular in each of the displacement positions, at least one function of the household appliance can be controlled or adjusted, which cannot be controlled or adjusted in the other displacement position. The operating element can in particular control one or more functions of the household appliance both in the first displacement position and in the second displacement position, in particular in each of the different displacement positions. This is not strictly necessary.

Displacement positions of the operating element in which at least one function of the appliance can be controlled or adjusted are also referred to as functional displacement positions. In addition to the functional displacement positions, the operating element can have an off position in which no functions of the appliance can be controlled. It is also possible that one of the displacement positions forms the off position, and at least one function of the appliance can be controlled in the off position.

The operating element can in particular have two, three, four or five different displacement positions. It can be provided that the household appliance is switched off when the operating element is in a certain displacement position, in particular in the first displacement position, which is also referred to as the off position.

Functions can in particular be a selection of a certain appliance from a list of available appliances, the power or power level of a hob, the power or power level of an extractor, the control of a gas flame, a timer, a temperature setting, general settings for the cooking appliance, in particular a date setting, time setting, location setting or a setting of other individual details, a volume setting, a lighting setting, a programme selection, in particular from a selection of cooking programme, or other.

It can in particular be provided that a hob can be controlled by means of the operating element in a first displacement position and another hob or an extractor can be controlled by means of the operating element in a second displacement position.

It can in particular be provided that a first hob can be controlled by means of the operating element in a first displacement position and another hob can be controlled by means of the operating element in a second displacement position and both hobs can be controlled together in a so-called bridge function by means of the operating element in a third displacement position.

The operating element can in particular be moved into different displacement positions, which correspond to different operating levels, by a linear displacement, in particular a horizontal displacement such as pulling out or pushing in.

The appliance can, for example, be controlled as follows:
At the start, the operating element is in an initial position. This can be the first displacement position, in particular the off position. The display can be exposed, i.e. visible, or concealed.
The operating element, in particular in the form of an operating knob, can be moved into a second displacement position by pushing it in and/or pulling it out. A certain operating level can be achieved thanks to this altered horizontal position of the operating element. The display can also move horizontally with the operating element. In this operating level, a specific function can be set, for example by turning the operating element and in principle also the display. For example, the power level of a hob or extractor can be set or a menu item in an operating menu can be set.
Another displacement position can be achieved by further pushing in and/or pulling out the operating element. Another operating level can be achieved thanks to this further altered horizontal position. The display can also move horizontally with it. In this operating level, a specific function can likewise be set, for example by turning the operating element and in principle also the display. For example, the power level of a hob or extractor can be set or a menu item in an operating menu can be set.
Finally, the operating element and display can be moved back to the initial position.

The display device can in particular be oriented horizontally, at an angle, in particular at an angle forward, or vertically, at least in sections, in particular completely.

As a result, the ergonomics of the operating device can be improved.

The display orientation can in particular be adapted to the arrangement of the operating device in the kitchen unit.

The display device can in particular be arranged with an angle of inclination in the range of 0° to 60°, in particular of no more than 45°, in particular no more than 30°, in particular no more than 15°.

The angle of inclination can also be at least 10°.

The display device can have a viewing angle of no more than 70°, in particular no more than 60°, in particular no more than 50°.

This improves the visibility of the display device.

The viewing angle is the maximum angle between the line of sight of an average user in a typical position in front of the household appliance and a surface normal to the display device. The surface normal can have a location-dependent orientation for curved displays. A small viewing angle enables good visibility of the display device. If the viewing angle gets too big, the display is more difficult to read.

The display device, in particular a display surface, can be planar or curved. It can be arranged on a ring, in particular a cylinder or cylinder section, or on a truncated cone or truncated cone section. Alternative arrangements are possible.

The display device, in particular a display surface, can extend around a central axis of the operating device. It can in particular extend around the central axis of the operating device over an angular range b of 5° to 120°, in particular no more than 100°, in particular no more than 90°, in particular no more than 80°.

This ensures easy readability.

It can also extend over the entire circumference (b=360°).

The display device, in particular a display surface, can consist of one or several parts.

The display device can be designed as a single, continuous piece. It can also have a plurality of separate, in particular spaced apart subregions, in particular subregions formed as a single, continuous piece.

The operating device can have one or more operating regions. It can in particular have different operating regions, for example a rotary region and a touch region.

The operating device can have one or more display regions. It can in particular have different display regions. It can in particular have an alphanumeric display and a graphical display. The operating device can also be coupled to a display, in particular a separate display. The display can be mounted on the hob, in particular integrated into the hob. It can also be an external display. The operating device can in particular be coupled to a display of a mobile device, in particular a mobile telephone, tablet, laptop or wearable. As a result, the menu-guided control and/or operation of the appliance can be improved, in particular simplified.

The display device can have a screen or display. It can be an LED display, an LCD display, a TFT display or an OLED, AMOLED, micro-LED, or matrix-LED display. It may be an electronic paper display. Alternatives are also possible.

The operating device, in particular the display device, can also have a touch-sensitive display.

The display device can also have a projection device. The projection device can have a DLP (Digital Light Processing) projector or a DMD (Digital Micromirror Device) projector.

The projection device can be designed in such a way that the information for adjusting the household appliance is projected onto a surface of the operating device. The information can in particular be projected onto the surface of the operating element, such as an outer and/or inner lateral surface and/or a front surface of same. The projection device can also project corresponding information onto a floor, a ceiling or a wall. The projection device can also be used to project the information onto other objects, such as pots or pans, or transparent bodies (head-up technology).

The display device can in particular have a projection device which projects from the surface of the hollow knob. It can project backwards or forwards.

The projection device can have optical components, in particular one or more mirrors, lenses or prisms.

The display device can in particular not be permanently visible. It can be concealed, in particular invisible, in particular in a certain displacement position of the operating element, in particular in an off position. For example, the display device can be invisible to the user in a certain displacement position of the operating element.

The operating element can be transparent or translucent.

The operating element can be made of metal, plastic, wood, stone or glass. Combinations are also possible. Alternatives are also possible.

According to another aspect, the display device can be arranged behind the operating element in an axial direction. It can in particular be arranged between a wall of a kitchen unit, in particular a front panel, and the operating element.

It can in this case be particularly reliably protected by the operating element against damage.

According to another aspect, the display device can be axially planar and radially convex, or axially diagonal and radially convex, or axially diagonal and radially rectangular. The specifications axial and radial relate in particular to the axis of rotation about which the operating element can be rotated. The axial direction can in particular be oriented normal to a front side of the kitchen unit on which the operating device is arranged. The radial direction runs in particular perpendicular to the axial direction.

Each of these embodiments enables the display device to be read particularly easily.

According to another aspect, the operating element can be ring-shaped, elliptical or polygonal. The operating element can in particular be designed as a hollow knob.

It can have a circular or a non-circular, in particular elliptical or polygonal, cross-section.

This makes it possible to use the space surrounding the operating element for other functional components and/or to display information.

The display device can in particular be arranged on an outside of the attachment device and/or on an inside of the operating element.

According to another aspect, the operating device can have a light device with one or more light sources, in particular in the form of LEDs.

The LEDs can have different colours. They can be controllable LEDs.

According to another aspect, the operating element can have a touch-sensitive sensor. It can also have a button and/or a switch.

The touch-sensitive sensor can be flat or bent. It can in particular have a flat or a bent, curved surface.

The touch-sensitive sensor can be arranged on an outside of the operating element, in particular around its circumference. This means that the operating element can be operated by touching the outside.

In particular in the case of a hollow knob, the touch-sensitive sensor can be arranged on an inside of the operating element, in particular around its circumference.

The operating device can in particular enable a hybrid operating concept. This means that different input forms are possible for operation. A selection of mechanical inputs, touch signals, optical signals, in particular gesture control, acoustic signals, in particular voice control, can in particular be provided as input forms.

The operating device can in particular have one or more optical sensors. This can enable gesture control.

The operating device can in particular have one or more acoustic sensors, in particular microphones. This can enable voice control.

According to another aspect, the operating device can have means for producing haptic feedback, in particular in the form of a structure-borne sound converter or an eccentric mechanism.

This enables haptic feedback.

According to another aspect, the operating device can be context sensitive.

This means that it can be adapted to different requirements, in particular to different household appliances. It can in particular be designed in such a way that it automatically adapts to different requirements, in particular to different household appliances.

Other objects of the invention involve improving a hob and an extractor.

These objects are achieved by a hob and an extractor with an operating device according to the preceding description.

The hob can in particular be a combined appliance made of up of a hob and an extractor. Such a combined appliance is also referred to as a hob extractor.

According to one aspect, the operating element can be used to control the hob in a first displacement position and to control the extractor in a second displacement position.

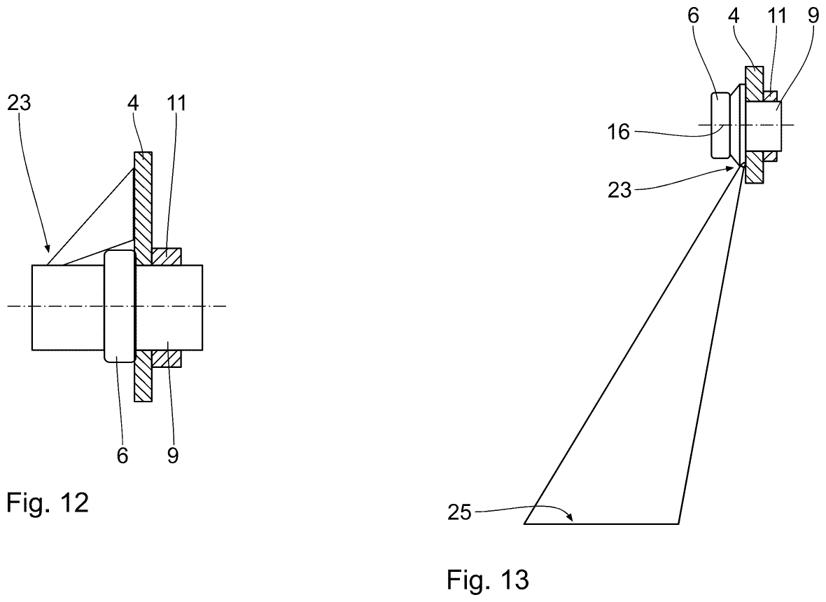

The hob, in particular the hob extractor, can be modular in design. It can also be designed as a mounting unit. For details of such a mounting unit, reference is made to WO 2012/146 237 A1, in particular the exemplary embodiment according to FIGS. 12 to 16.

Other optional details and advantages of the operating device are described briefly below. The following features are not mandatory features. They can be respectively implemented individually or in combination with one another or in combination with one or more of the features described above.

In the off state, the operating element can cover and thus protect the display device.

When the kitchen appliance is switched on, the operating element can be displaced into an operating position. It can in particular be displaced forwards in an axial direction. The display device can be exposed and thus visible here.

The display device can have a high-resolution graphic display.

The operating device enables the kitchen appliance to be operated particularly ergonomically.

The operating device enables the display device to be read particularly ergonomically.

The operating device enables a flexible, intuitive operating and/or display concept.

The flexible arrangement and/or orientation of the display device enables additional flexibility when designing the operating device.

The operating device enables simple assembly.

The operating device can control different kitchen appliances and/or their components.

The operating element can have one or more touch-sensitive regions. It can in particular have a touch operating surface axially in the centre. It can in particular have one or more touch operating surfaces around its circumference.

The operating device can have one or more seven-segment displays.

The display device can have backlit icons.

The attachment device can be suitable for assembly in a hole with a diameter of 10 mm to 70 mm. Alternatives are possible.

The attachment device can in particular surround a receiving space. It can preferably be tubular. Elements of the controller, in particular control electronics, in particular one or more printed circuit boards with control electronics, can be arranged in the receiving space. For details, reference is made to DE 10 2020 207 162 A1.

The operating element can have different degrees of displacement freedom. It can in particular have a combination of one or more of the following degrees of displacement freedom: linear displaceability, rotary displaceability and pivotability, in particular about an axis perpendicular to the axial direction of the operating device, in particular about an axis parallel to a front side of the kitchen unit in which the operating device is installed.

In order to unlock and/or activate the operating device, a multi-component travel can be provided. For example, it is possible to design the operating device in such a way that the operating element has to be both linearly displaced and rotated for activation. For example, the operating device can be unlocked and/or activated by pushing in and simultaneously or subsequently rotating a component, in particular the operating element.

The travel of the release movement is, for example, in the range of 10 mm to 30 mm and/or in the range of 10° to 90°, in particular 10° to 45°.

In order to provide haptic feedback, magnets or mechanical elements can be provided, such as a toothed ring with a spring which is pressed into the toothed ring.

A displacement of the operating element can be supported by lift cylinders. A push-pull mechanism can in particular be provided. The displacement of the operating element can be activated by pressing. A push-to-turn mechanism can also be provided.

The operating device can comprise a hollow shaft.

The operating element can be arranged on a hollow shaft.

Electronic components of the operating device can be integrated into the hollow shaft.

The operating element can be designed as an operating control ring, in particular a glass ring or metal ring.

The operating element can release the display device by a linear displacement, in particular forwards, and/or by tilting, in particular about a horizontal axis.

The operating element can be mounted without stops. It can in particular be mounted on the attachment device without stops.

A stop can also be provided to define an end point, in particular a zero point.

The operating element can be removable. It can in particular be removably mounted on the attachment device.

The operating device can in particular be designed in such a way that the display device remains arranged on the kitchen unit when the operating element is removed.

The display device can also be arranged internally, in particular internally within or on the operating element. It can in particular be arranged on an inwardly facing surface, in particular a surface facing the axis of the operating device. This surface can be cylindrical or frustoconical in shape. Alternative geometries are possible.

The display surface can be formed by a region of the operating element. This is in particular possible with a translucent design of the operating element.

The display surface can in particular be formed by a region in the front side of the operating element and/or by a circumferential region of the operating element.

The operating element can be backlit.

The display device can be backlit.

The operating device can have a rotary encoder.

The attachment device can have an attachment sleeve. The sleeve can be formed integrally with the central piece. The sleeve and central piece can also be formed as separate components. The sleeve can be connected to the central piece in particular when the operating device is installed.

The sleeve can rest against the unit front in particular in the installed state or be spaced apart from the unit front by no more than 2 mm, in particular no more than 1 mm. An intermediate element, in particular an intermediate ring, can in particular be arranged between the sleeve and the unit front. This can compensate for any unevenness. The sleeve can also be isolated from the unit front by means of the intermediate element.

The display device can be integrated into the sleeve.

The display device can in particular be oriented and/or designed in such a way that it has an upward facing component and a forward facing component.

The display device can in particular be adapted to different installation situations and/or to different user constellations, in particular different body sizes. For example, the orientation of the display device, in particular the viewing angle, can be selected depending on the installation position of the operating device and/or body size of the user.

The display device, in particular a display surface of same, can in particular be designed in such a way that the display surface is optimised, in particular maximised, in such a way that a maximum specified viewing angle for a typical user is not exceeded. The maximum specified viewing angle can be no more than 80°, in particular no more than 70°. A typical user can be assumed to have their eyes, for example, at a height of 140 cm to 180 cm and at a distance of, for example, 5 cm to 25 cm from the household appliance which is installed, for example, in a kitchen base cabinet with a maximum height of 95 cm.

Further advantages and details of the invention result from the description of exemplary embodiments based on the figures. In the drawings:

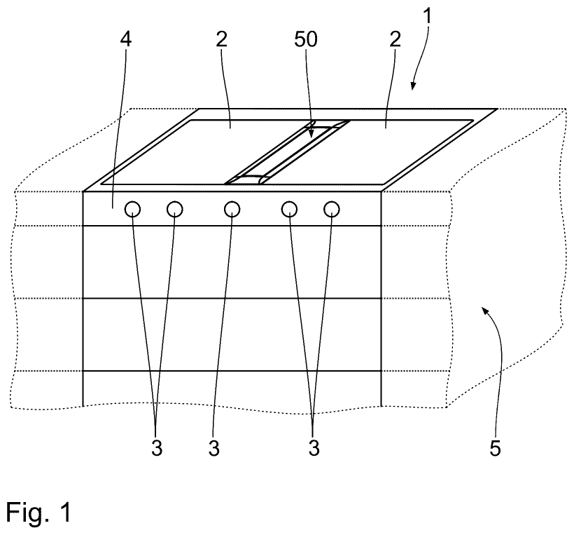

FIG. 1 shows a schematic illustration of a household appliance in the form of a hob-extractor system with two hobs, an extractor and five operating knobs,

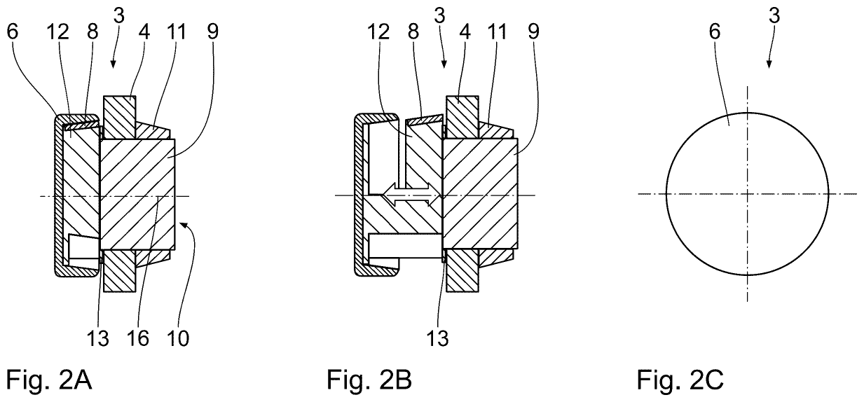

FIGS. 2A and B show sectional illustrations of an operating knob according to one variant,

FIG. 2C shows a view of the operating knob according to FIGS. 2A and B from the front,

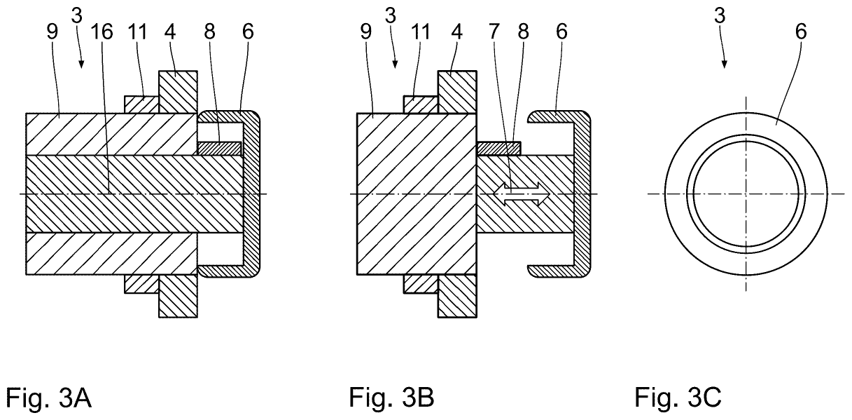

FIG. 3A to 3C show views according to FIG. 2A to 2C of another variant of an operating knob,

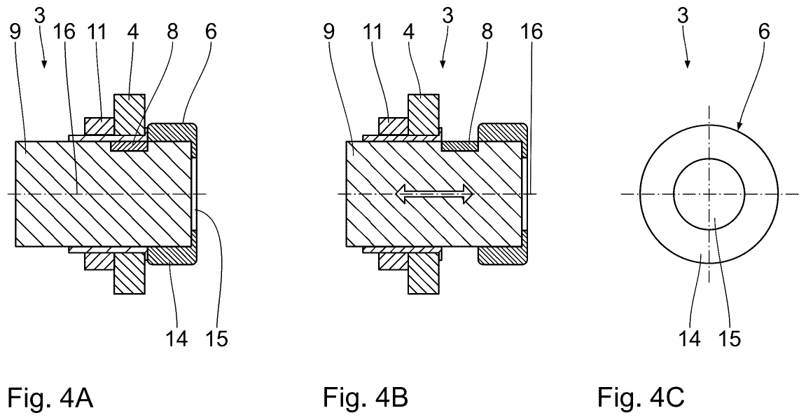

FIG. 4A to 4C show views according to FIG. 2A to 2C of another variant of an operating knob,

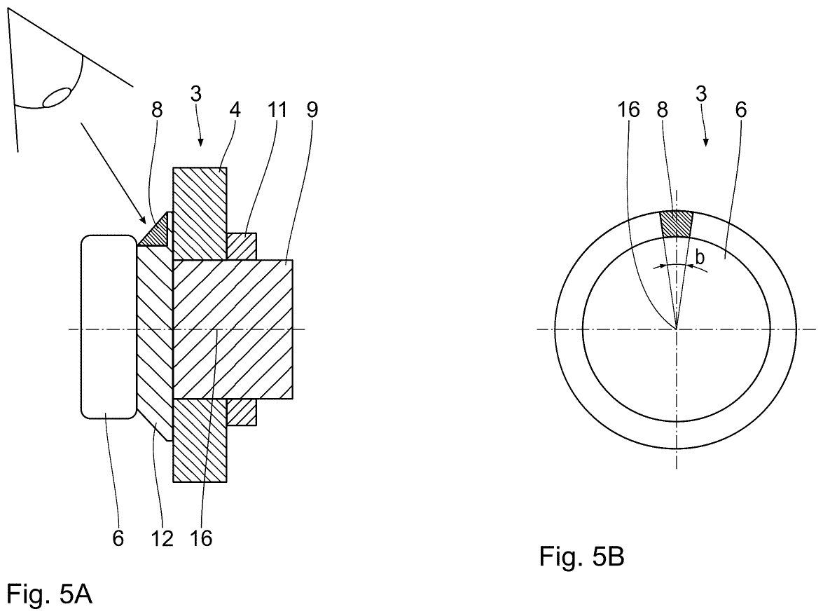

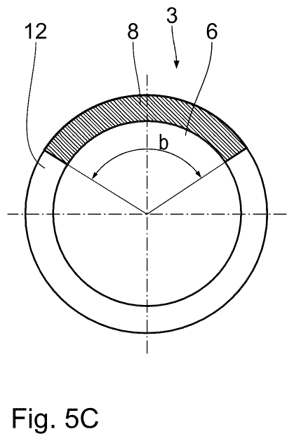

FIGS. 5A and 5B show views according to FIGS. 2B and 2C of another variant of an operating knob,

FIG. 5C shows a view in accordance with FIG. 5B according to another variant,

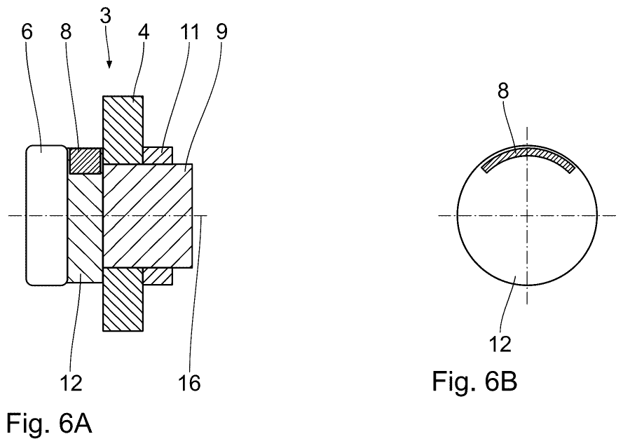

FIG. 6A shows a view according to FIG. 2B of another variant of an operating knob,

FIG. 6B shows a view of the operating knob according to FIG. 6A from the front, wherein the operating element has been removed from the figure to illustrate the embodiment of a display device,

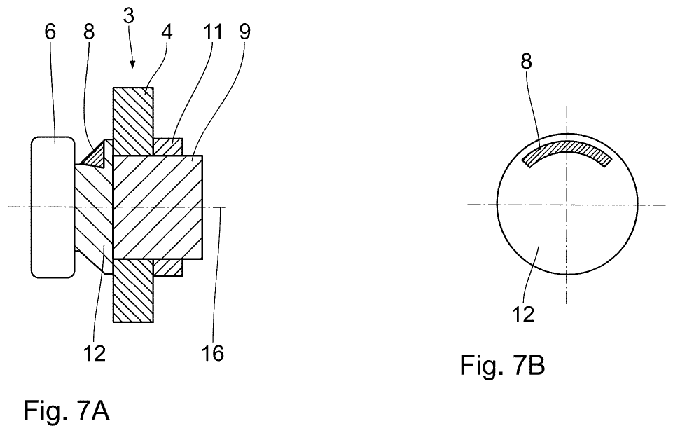

FIGS. 7A and 7B show views according to FIGS. 6A and 6B of another variant of an operating knob,

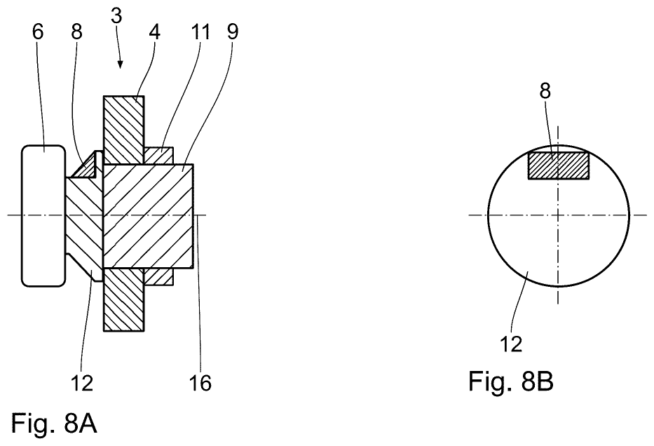

FIGS. 8A and 8B show views according to FIGS. 6A and 6B of another variant of an operating knob,

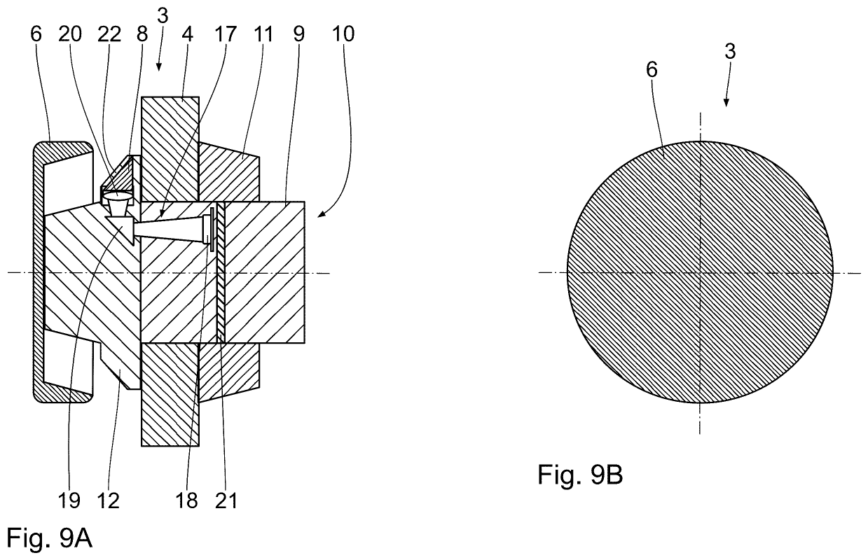

FIG. 9 shows a view according to FIG. 2B of another variant of an operating knob,

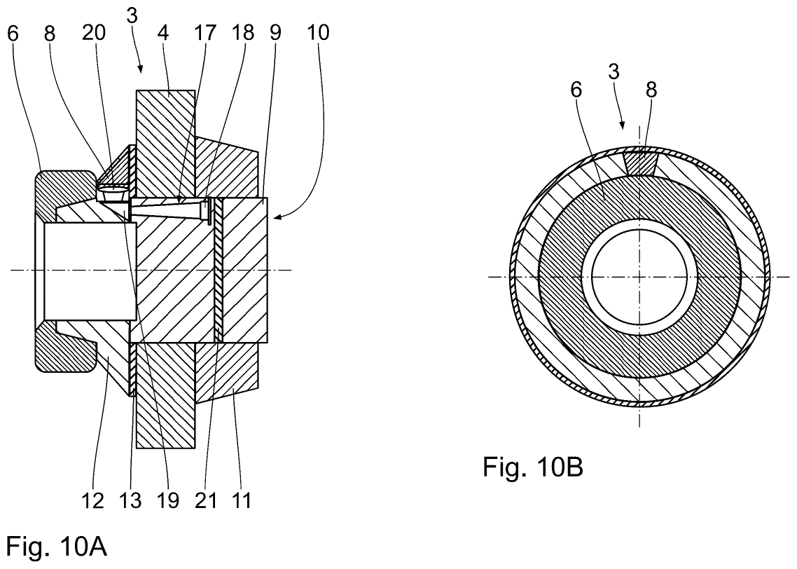

FIGS. 10A and 10B show views according to FIGS. 2B and 2C of another variant of an operating knob,

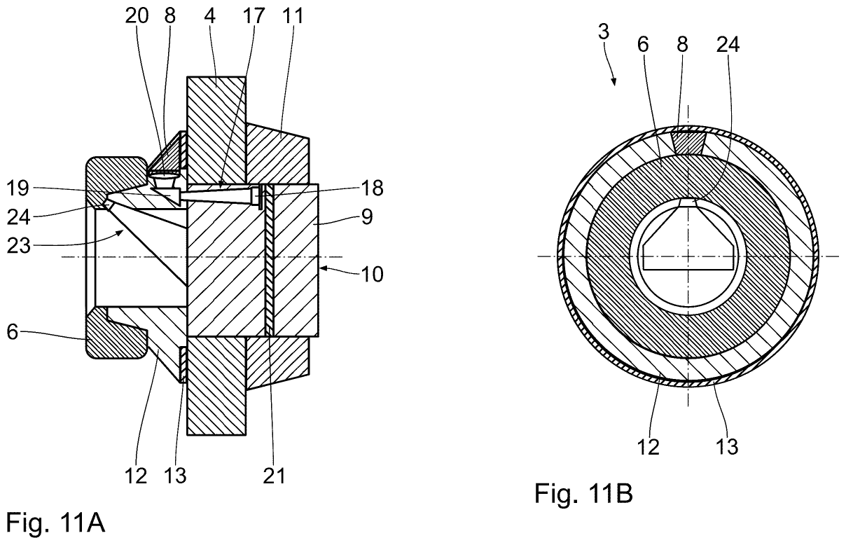

FIGS. 11A and 11B show views according to FIGS. 2B and 2C of another variant of an operating knob,

FIG. 12 shows a sectional view of another variant of an operating knob,

FIG. 13 shows a sectional view of another variant of an operating knob,

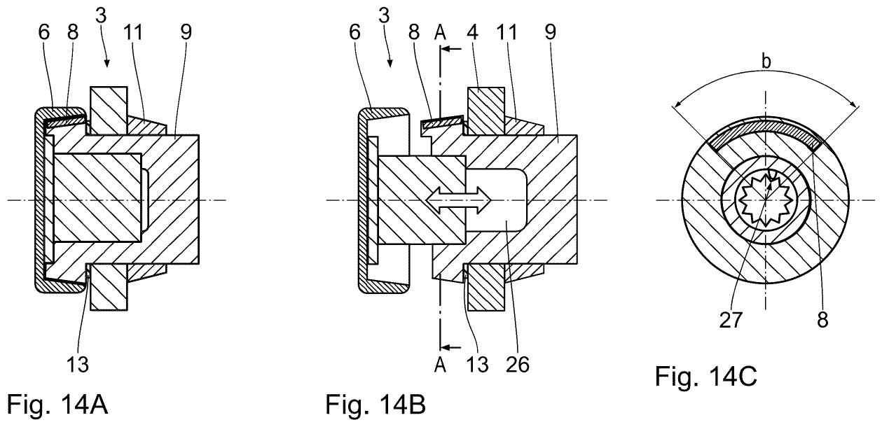

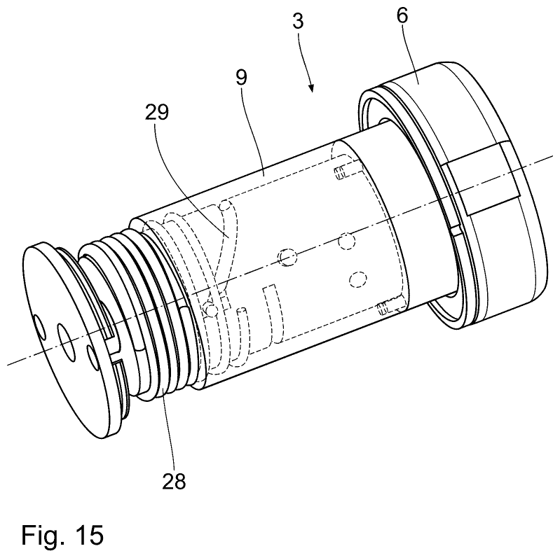

FIGS. 14A and 14B show views according to FIGS. 2A and B of another variant of an operating knob,

FIG. 14C shows a sectional view along the line A-A in FIG. 14B,

FIG. 15 shows a perspective view of another variant of an operating knob,

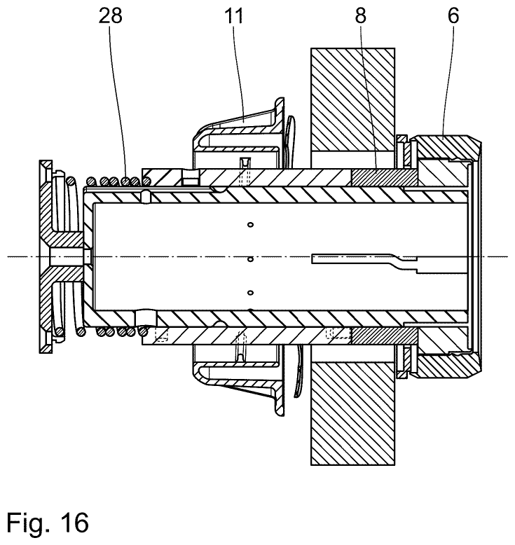

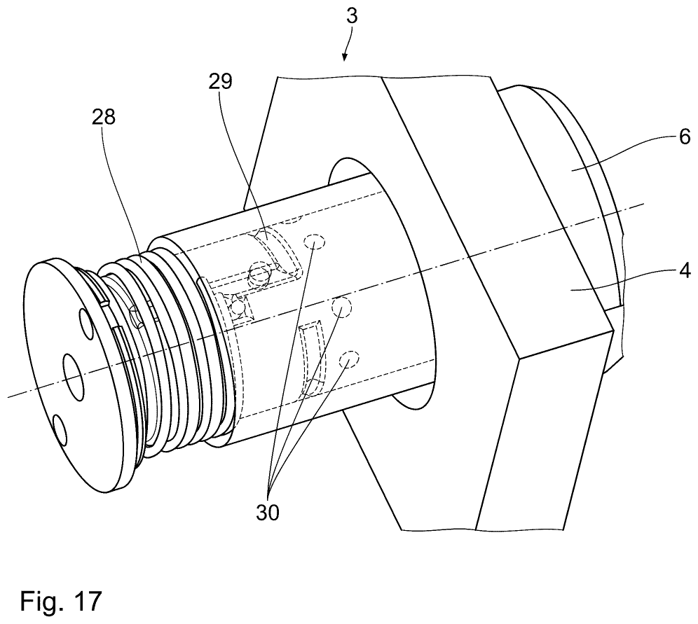

FIG. 16 shows a sectional view of another variant of an operating knob,

FIG. 17 shows a perspective view of another variant of an operating knob,

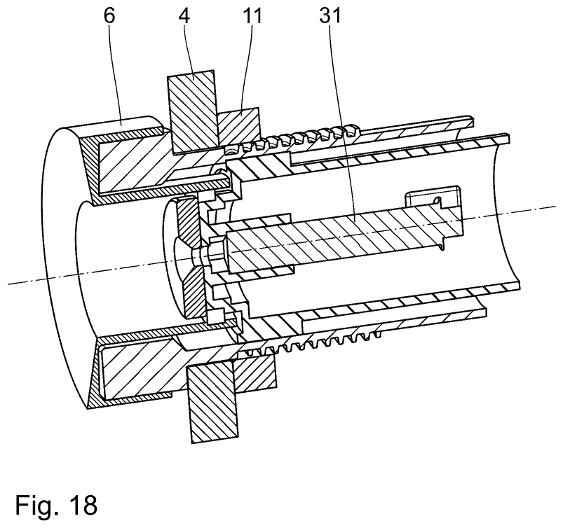

FIG. 18 shows a perspective sectional view of another variant of an operating knob,

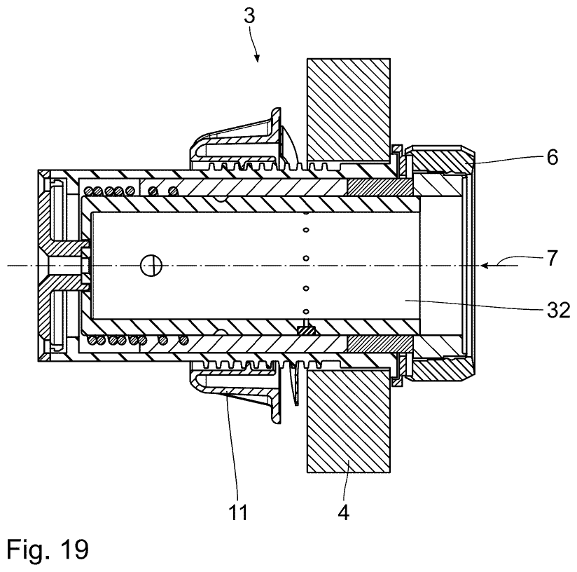

FIG. 19 shows a sectional view of another variant of an operating knob,

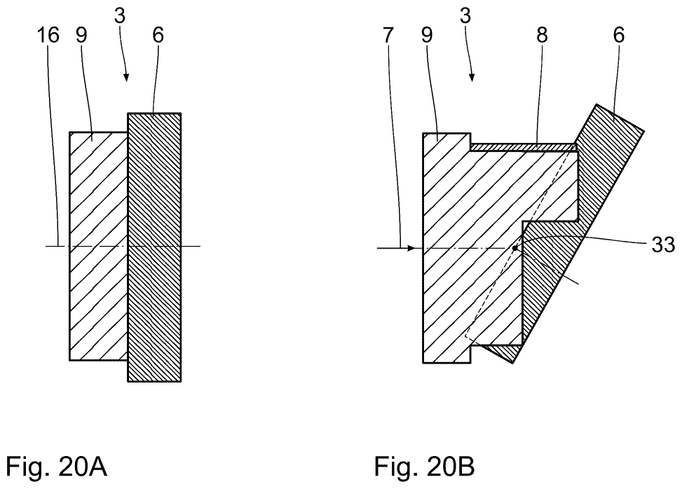

FIGS. 20A and 20B show views according to FIGS. 2A and 2B of another variant of an operating knob,

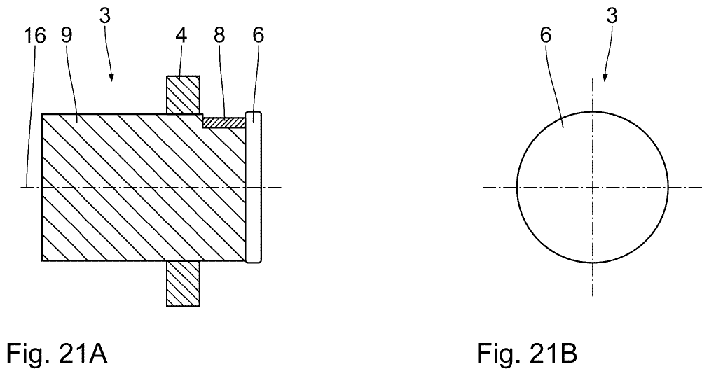

FIGS. 21A and 21B show views of another variant of an operating knob in the off state,

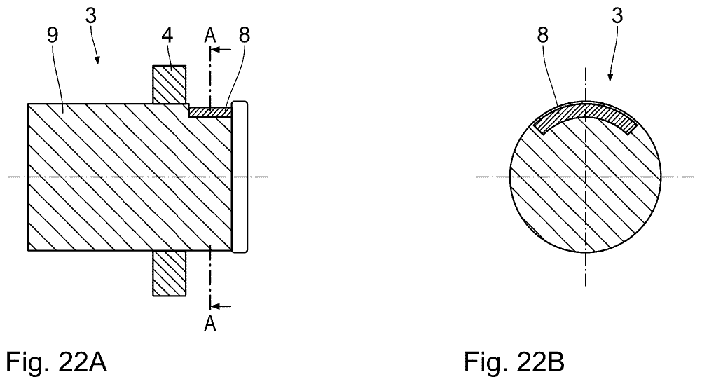

FIGS. 22A and 22B show views of the operating knob according to FIGS. 21A and 21B in the on state,

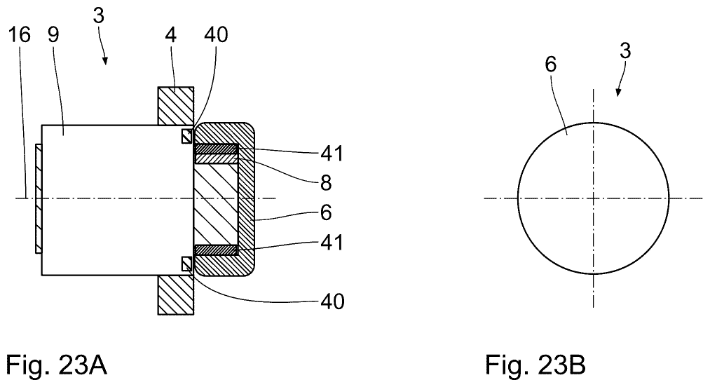

FIGS. 23A and 23B show views of another operating knob in the off state,

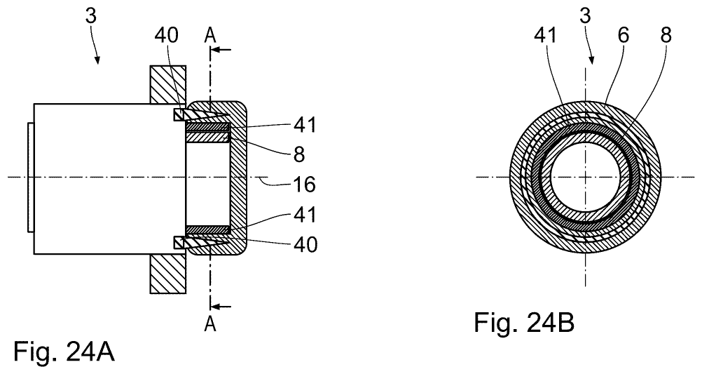

FIGS. 24A and 24B show views of the operating knob according to FIGS. 23A and 23B in the on state,

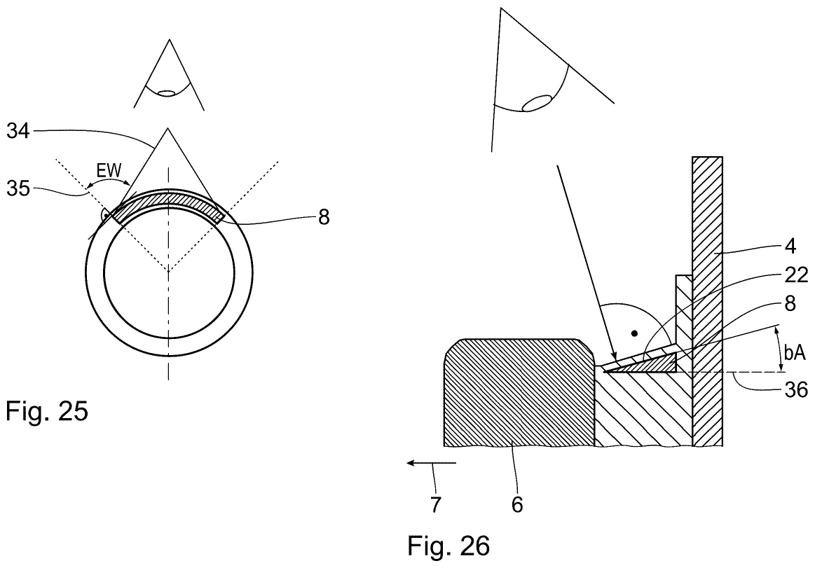

FIG. 25 shows a schematic view to illustrate the viewing angle and

FIG. 26 shows a schematic view to illustrate the angle of inclination of the display device

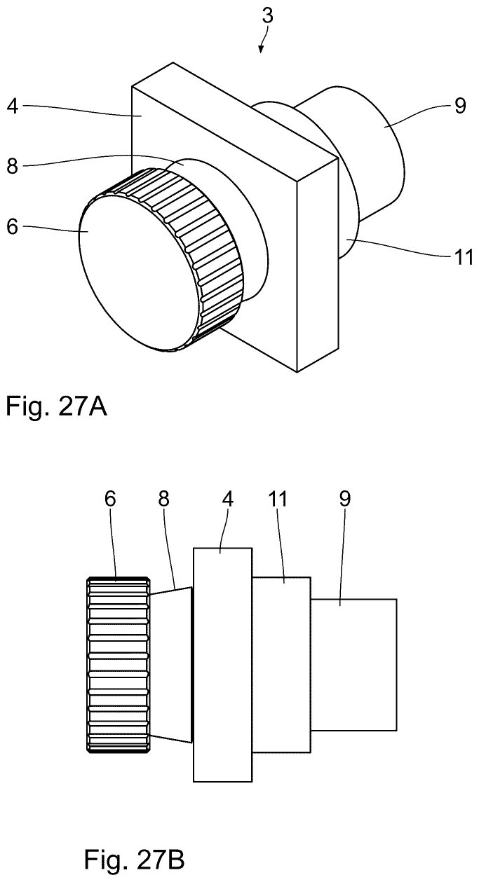

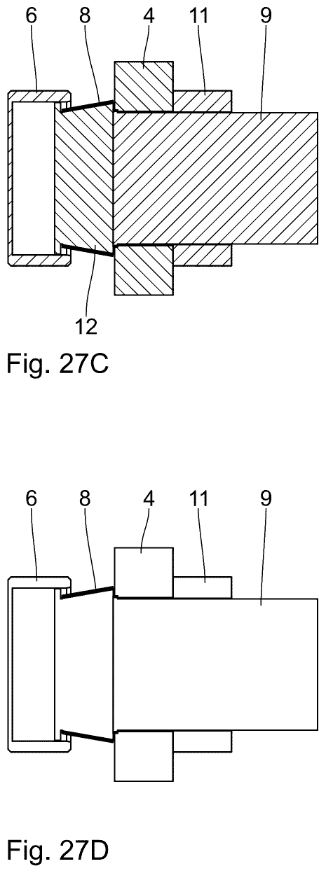

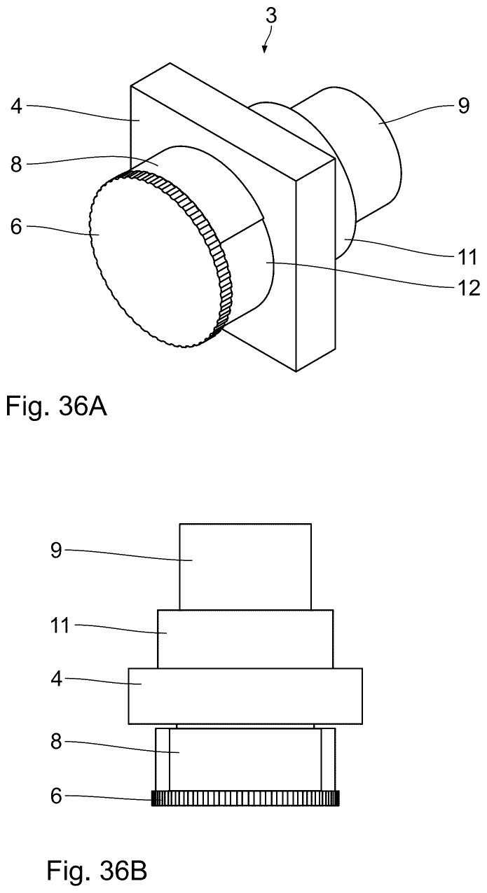

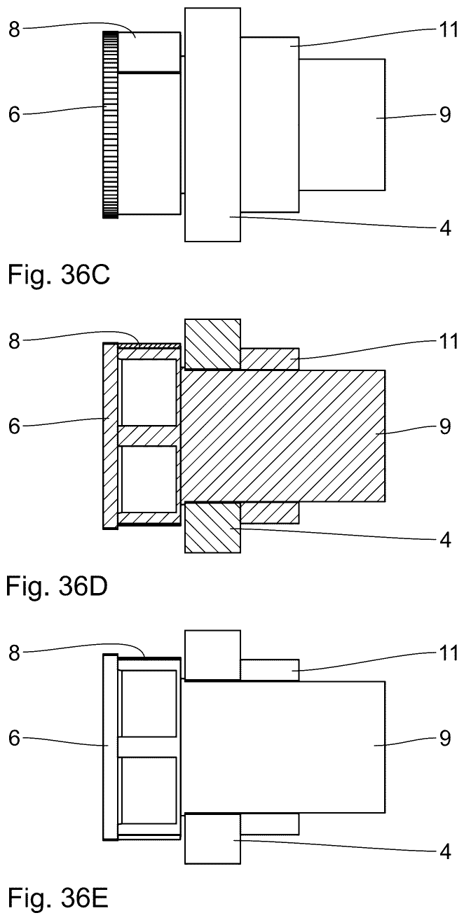

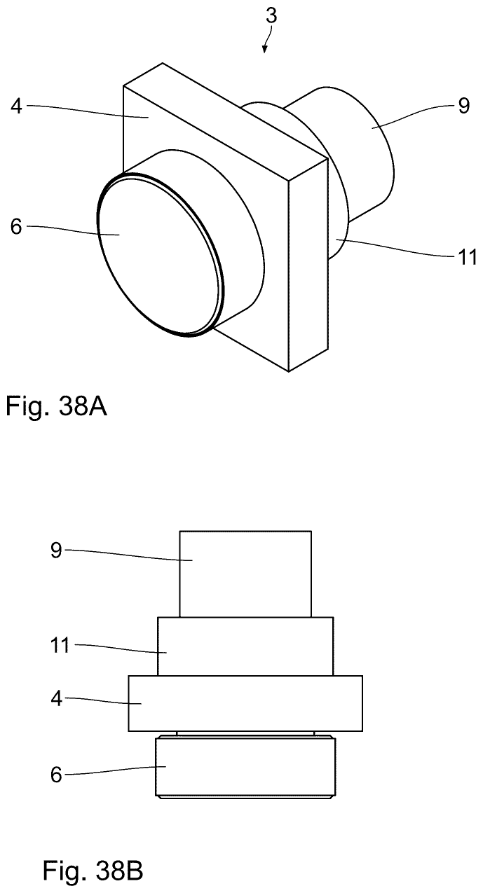

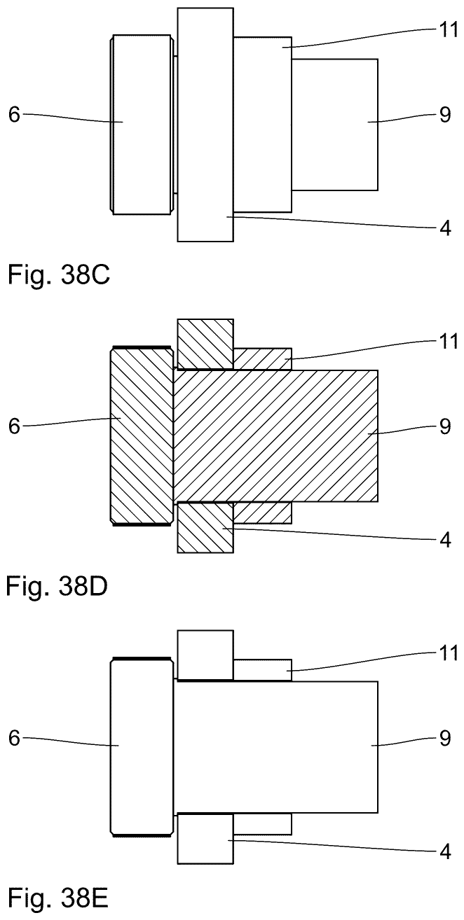

FIG. 27A to 40C show further views of different variants of an operating knob

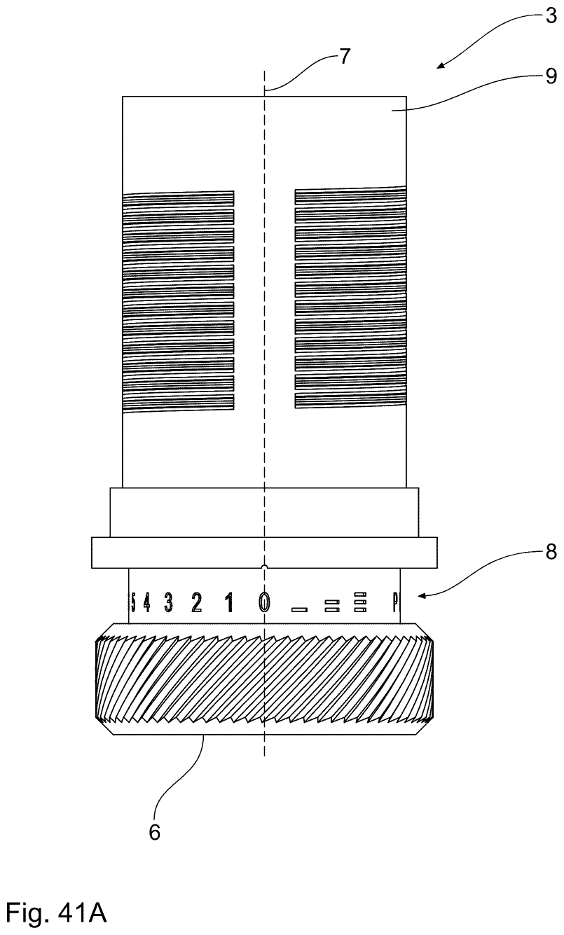

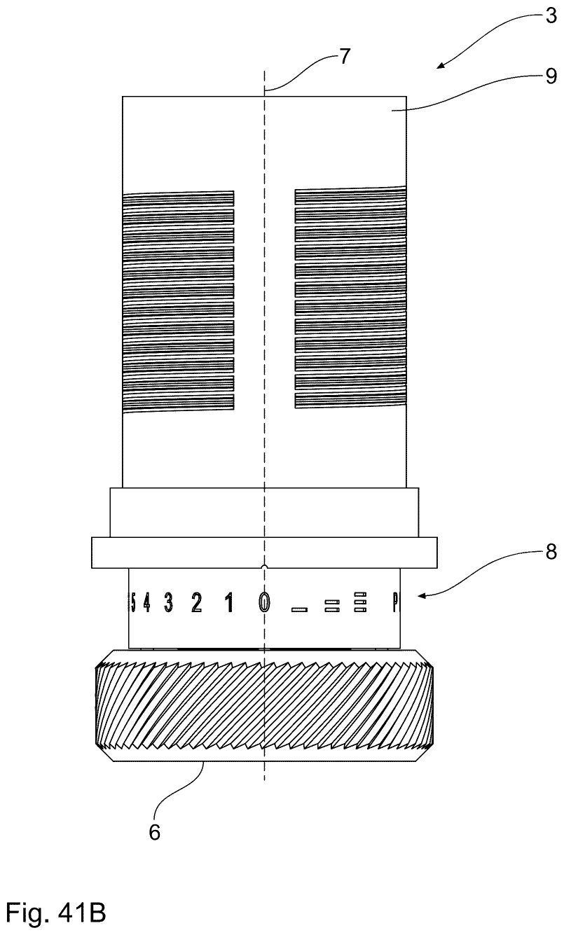

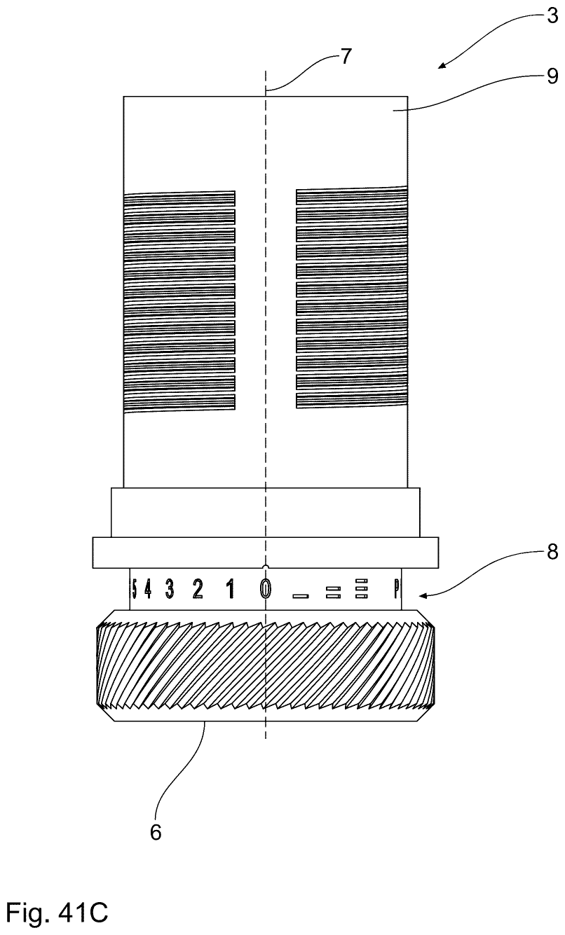

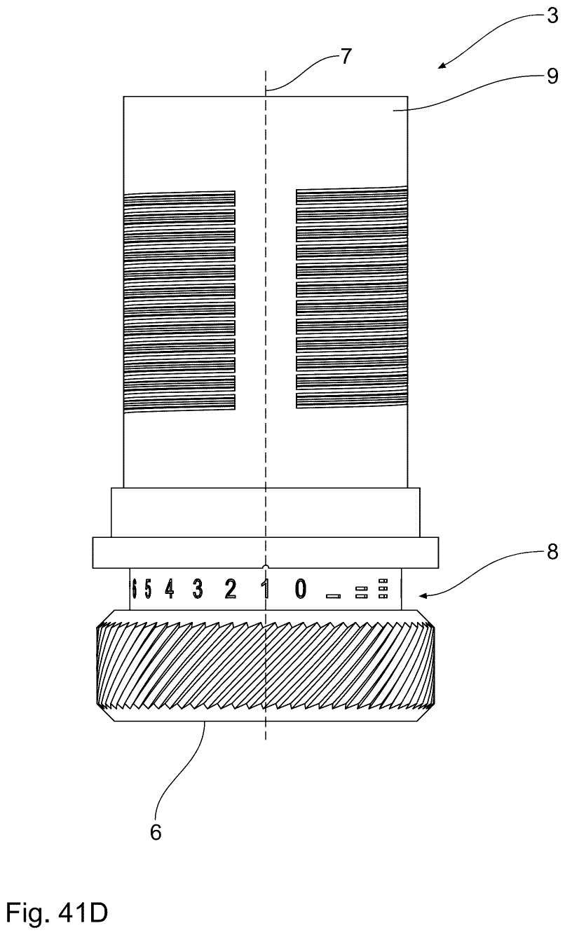

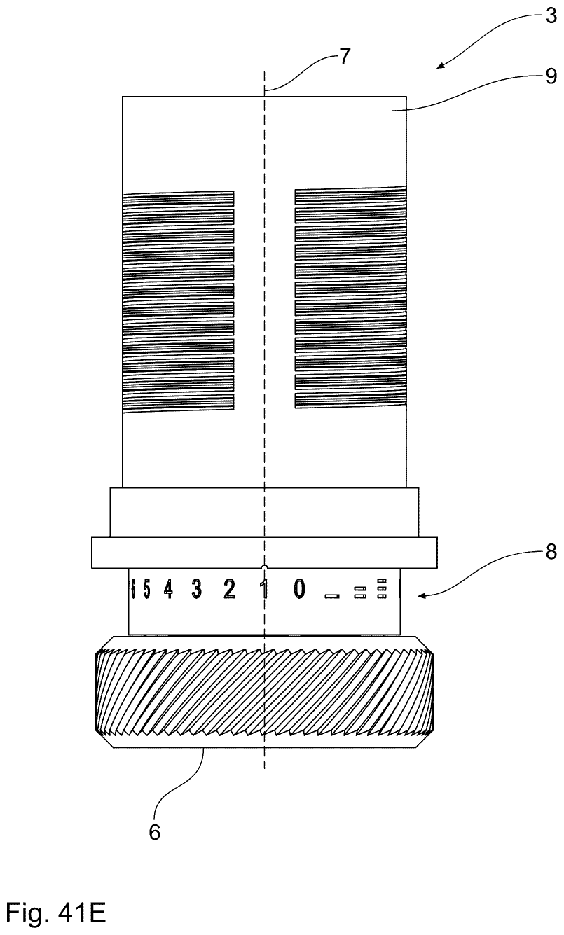

FIG. 41A to 41E show another variant of an operating knob.

The general components of a kitchen appliance, in particular in the form of a hob-extractor system 1, are initially described below. The hob-extractor system 1 comprises at least one hob 2. In the hob-extractor system 1 shown by way of example in FIG. 1, two hobs 2 are provided. The hob-extractor system 1 comprises at least one extractor (50). In the hob-extractor system 1 shown by way of example in FIG. 1, precisely one extractor (50) is provided.

The hobs 2 can be substantially any type of hob. It can in particular be an induction hob, electric hob, infrared hob, gas hob, Teppanyaki hob, wok hob, hotplate, grill or other hob.

In the embodiments shown by way of example in FIG. 1, operating knobs 3 are respectively provided for operating the hobs 2. In principle, a single operating knob 3 is sufficient for operating the hobs (2) and/or for operating the extractors (50). Operation by means of touch-sensitive sensors, which can be integrated in particular into the hobs 2 or operating knobs 3, is also possible. Operation via a separate operating module is also conceivable.

The various operating means can also be combined with one another.

Different variants of an operating device in the form of an operating knob 3 are described in more detail below.

Obvious similarities between the different variants of the operating knob 3 are not described again for each variant. In this respect, reference is respectively made to the preceding description.

The operating device is not limited to the operation of hobs (2) or extractors (50). It can be used universally, i.e. for any household appliance.

The operating devices described below are suitable in particular for operating, in particular controlling, the kitchen appliances or household appliances. They can in particular be used for operating, in particular controlling, hobs, extractors, hobs with integrated extractors, ovens, steamers, warming drawers, fryers, dishwashers, microwaves and other household appliances, such as washing machines, tumble dryers, or electrical appliances.

The operating knobs 3 can in particular be installed in the front panel 4 of a kitchen unit, in particular in the form of a kitchen base cabinet 5. This is not to be understood as limiting.

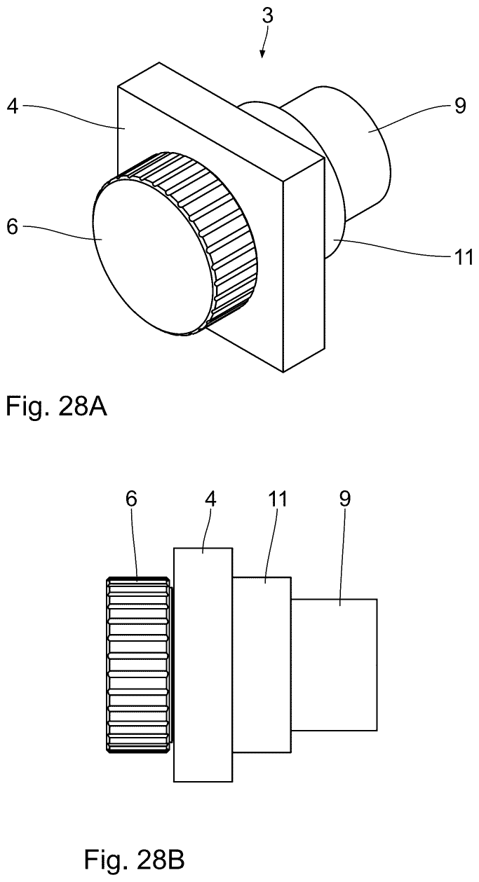

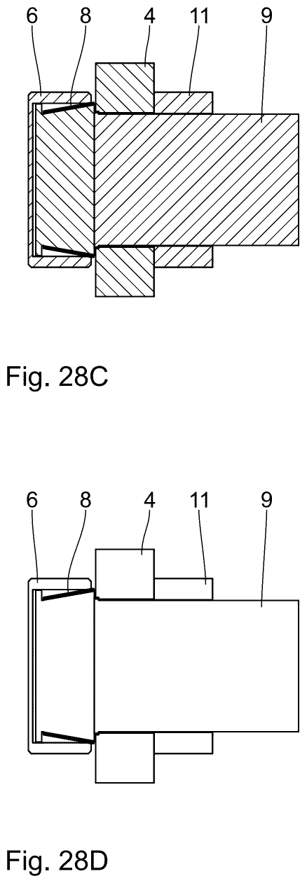

A variant of tan operating knob 3 is shown in FIGS. 2A to 2C. Other schematic views of a corresponding variant are shown in FIGS. 27A to 27D and 28A to 28D.

In FIG. 2A (FIG. 28A to D), an operating element 6 is in an off position.

The operating element 6 can be displaced in an axial direction 7. It can in particular be displaced from the off position shown in FIG. 2A to a second displacement position shown in FIG. 2B (FIG. 27A to D). The second displacement position is also referred to as the operating position.

A display device 8 is concealed by the operating element in the first displacement position. The display device 8 is exposed in the second displacement position. It is then in particular visible.

The display device 8 can in particular be arranged on a sleeve 12 of the attachment device. This is not mandatory.

The sleeve 12 can substantially rest against the front panel 4 of the kitchen unit. It can, however, be separated from the front panel 4 by an intermediate element 13. The intermediate element 13 can in particular be made of an elastic and/or electrically insulating material.

The operating knob 3 has an attachment device with a central piece 9. The central piece 9 can surround a receiving space 10. Components, in particular electronic components, in particular printed circuit boards, in particular printed circuit boards of the control electronics, can be arranged in the receiving space 10. The attachment device is used in particular for attaching tan operating knob 3 to the front panel 4. It can also be used as a mounting sleeve for components of a control unit. For further details, reference is made to DE 10 2020 207 162 A1.

The attachment device can be secured in the front panel 4 with a locknut 11. Alternative attachment concepts are possible.

In a front view (FIG. 2C), in particular only the operating element 6 can be seen.

The operating element 6 can in particular be made of metal or plastic. Alternatives are also possible.

In the examples shown in FIGS. 2A and 2B (FIG. 27A to D and FIG. 28A to D), the display device 8 is oriented at an angle.

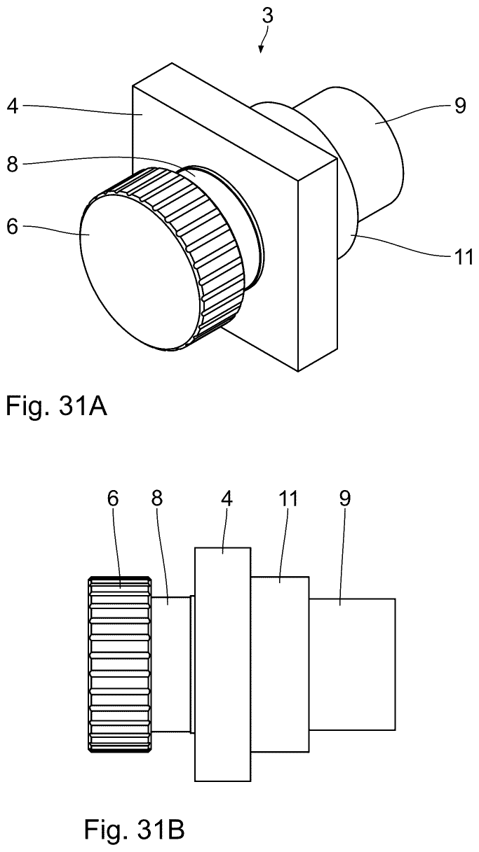

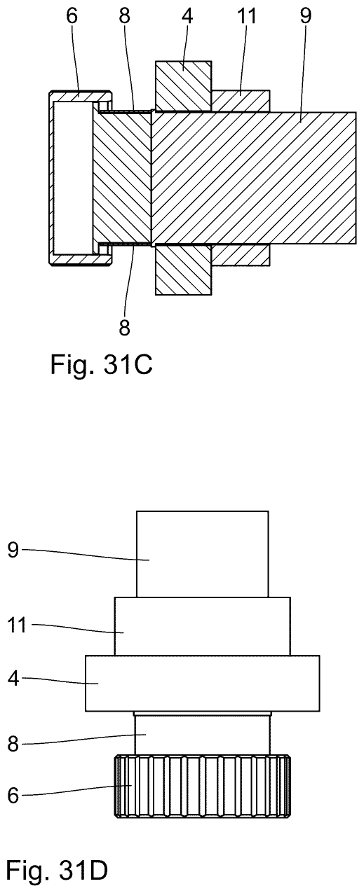

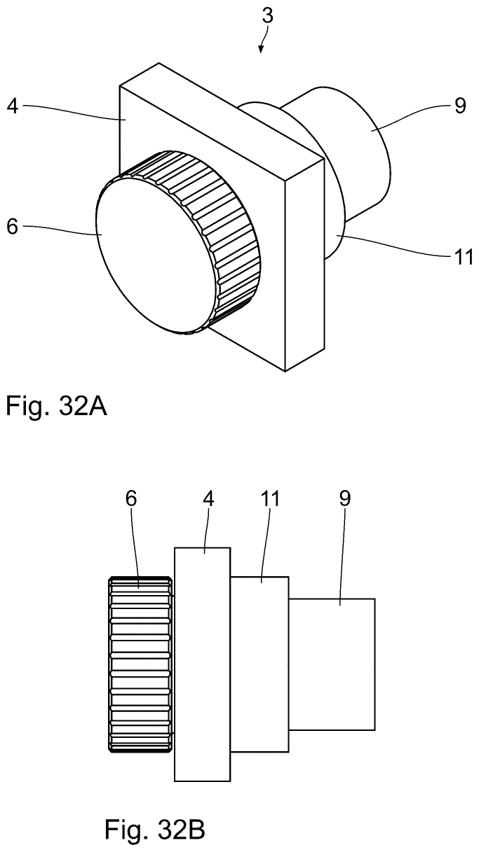

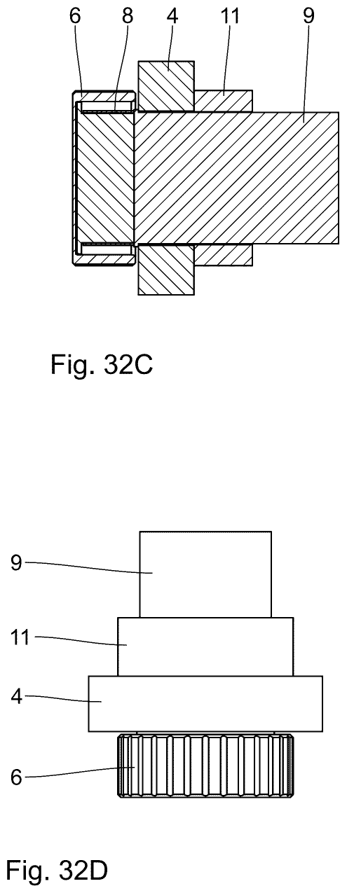

Another variant of tan operating knob 3 is shown in FIG. 3A to 3C. Other schematic views of a corresponding or similar variant are shown in FIGS. 31A to 31D and 32A to 32D.

In this variant, the display device is oriented horizontally. It can be planar or curved. It can in particular be arranged on a cylinder section of the attachment device, in particular the central piece 9. It can completely surround the central axis 16 of the attachment device (FIGS. 31A to D and 32A to D) or only partially surround it (FIG. 3A to C).

The operating device, in particular the operating element 6, can have a touch sensor. This is possible independently of other details of tan operating knob 3.

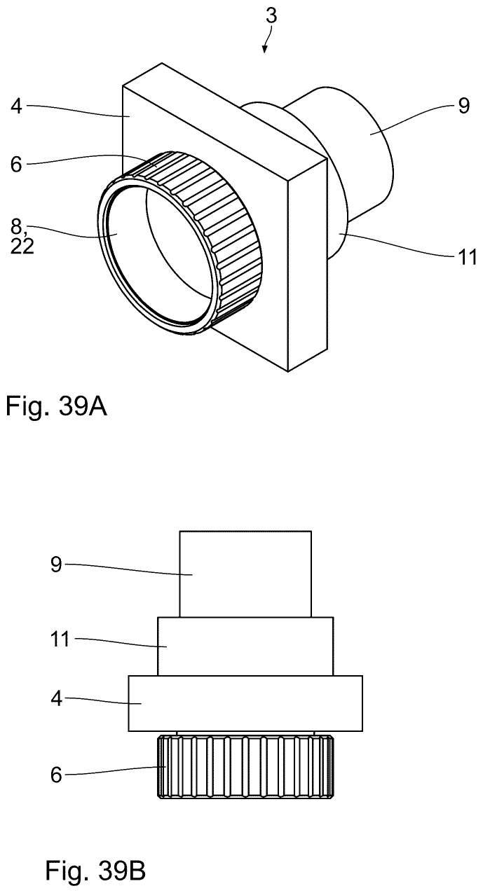

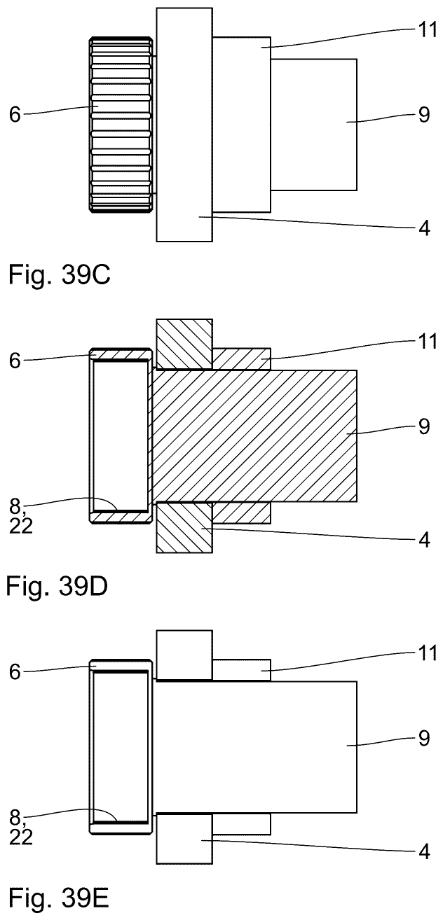

In another variant of tan operating knob 3 shown in FIG. 39A to E, the display surface 22 of the display device 8 is arranged on the inside of a ring-shaped operating element 6.

The display surface 22 can be oriented horizontally as in the variants according to FIGS. 3, 31 and 32 or at an angle forward as in the variants according to FIGS. 2, 27 and 28.

In this variant, the operating element 6 can be secured in the axial direction. It can also be displaced in the axial direction as in other variants.

The operating element 6 according to FIG. 4A to 4C has a rotary ring 14. The operating element 6 also has touch-sensitive surfaces 15 (touch panel; touch sensor). The touch-sensitive surface 15 is arranged centrally in the region around a central axis 16. Alternative arrangements are possible.

The touch-sensitive surface 15 can be circular. Alternative embodiments are possible.

The touch-sensitive surface 15 can be part of a touch display. It can in particular also be used to output information.

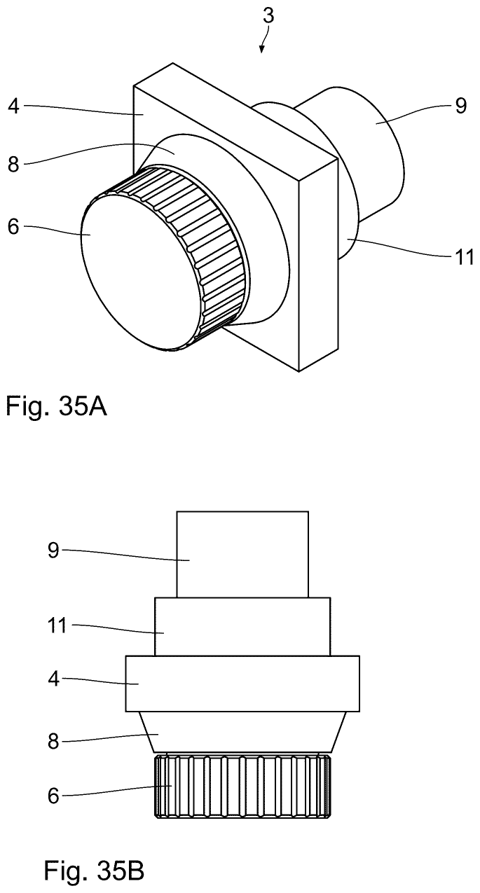

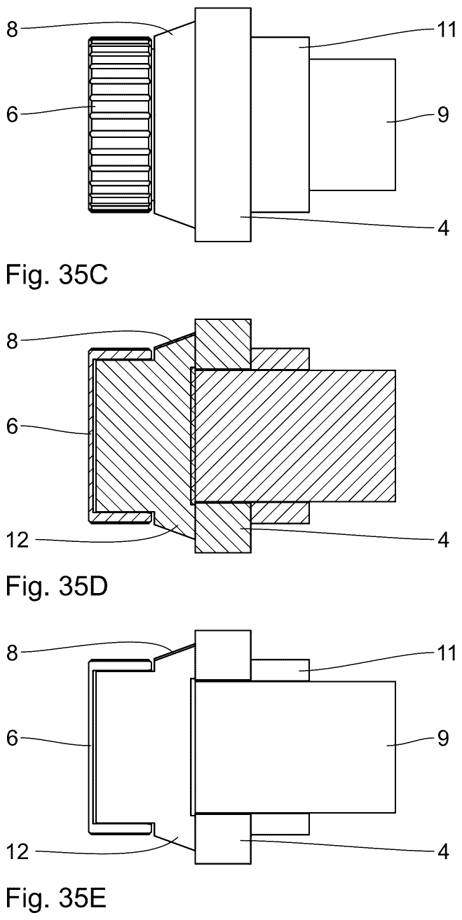

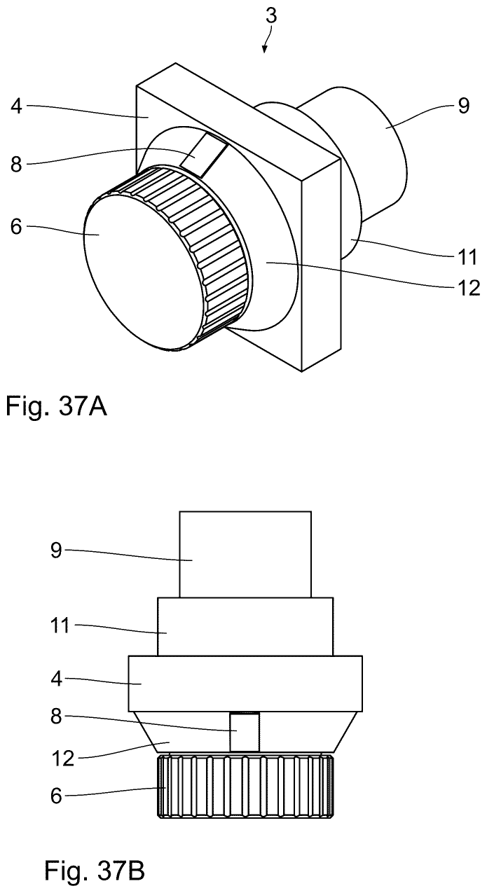

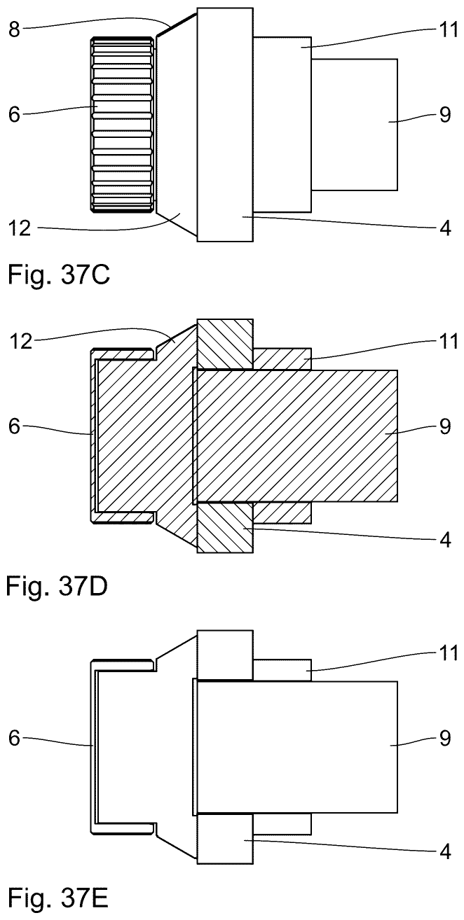

In the variants of tan operating knob 3 shown in FIGS. 5A and 5B, FIG. 35A to E and FIG. 37A to E, the sleeve 12, in particular the display device 8, protrudes beyond the operating element 6 in the radial direction.

The display device 8 is thus visible in a frontal view (FIG. 5B).

The sleeve 12 is visible in the frontal view as a surrounding ring around the operating element 6.

The display device 8 can in particular be oriented at an angle forwards and upwards. It can in particular only occupy a relatively small angular range b around the central axis 16. The angular range b can, for example, be in the range of 5° to 10°. It can also be up to 15°, up to 30°, up to 45°, up to 60° or up to 90°. Alternative angular ranges are also possible. The display device 8 can in particular also completely surround the central axis 15 (FIG. 35A to E). The angle b is then 360°.

The display device 8 can be shaped like a circular ring sector, in particular in a frontal view (FIG. 5B). The display device 8 can also be rectangular, in particular in a frontal view or in a view from above (FIGS. 37A and B).

A variant with a relatively large angular range b of a circular ring sector-shaped variant of the display device 8 is shown by way of example in FIG. 5C.

The display device 8 can in particular extend over a section of a surface of a truncated cone. The front side of the display device 8 can also be curved. It can in particular be convex or concave. It is also possible in the other variants of tan operating knob 3.

An operating knob 3 is shown by way of example in FIGS. 6A and 6B, in which the display device 8 is axially planar and radially convex. The display device 8 can in particular extend over a section of a cylindrical outer surface.

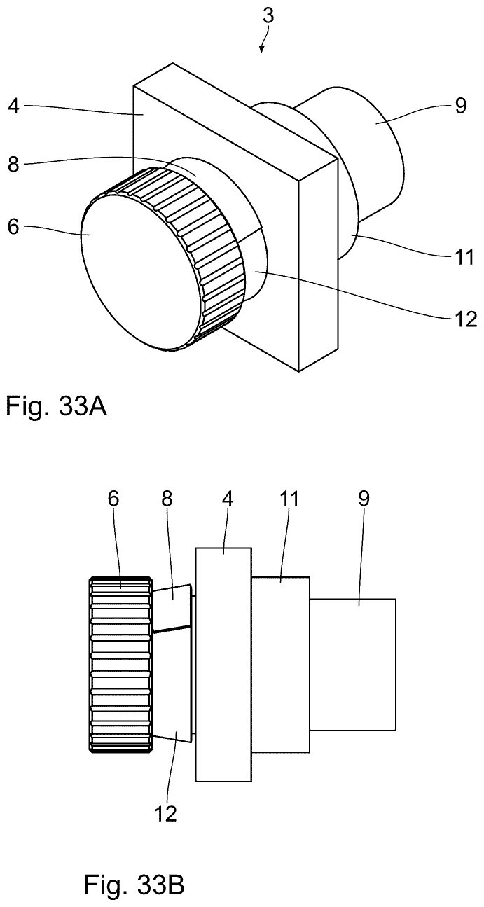

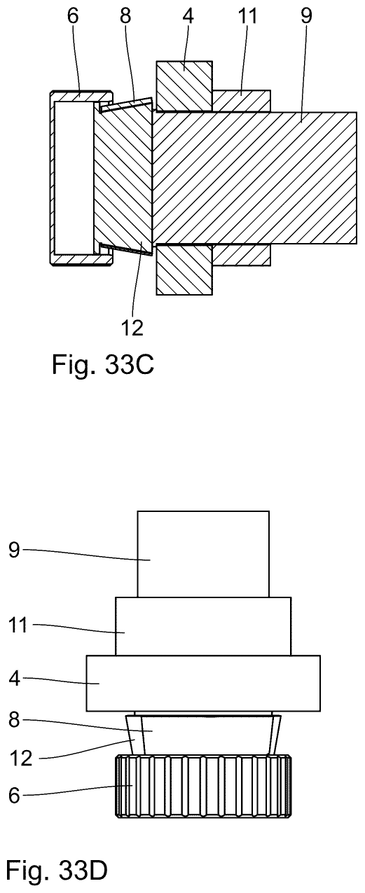

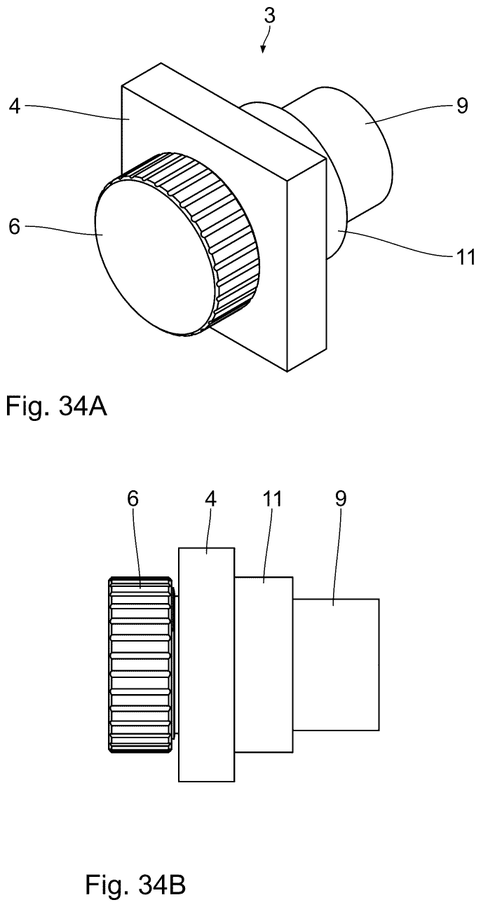

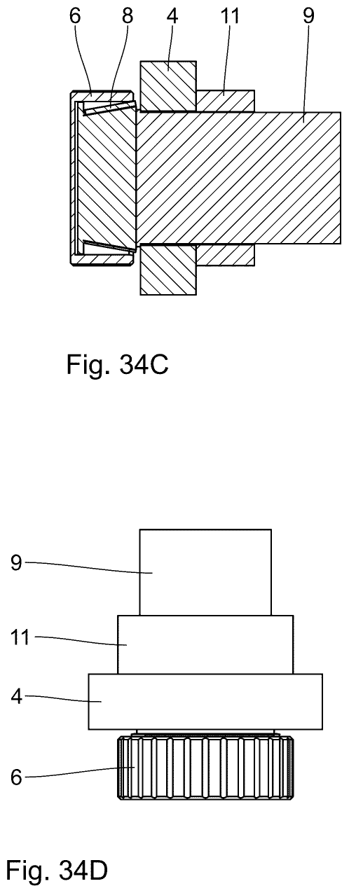

Variants are shown in FIGS. 7A and 7B, FIG. 33A to D and FIG. 34A to D, in which the display device 8 is axially diagonal and radially convex. The display device 8 can in particular extend over a section of an outer surface of a truncated cone.

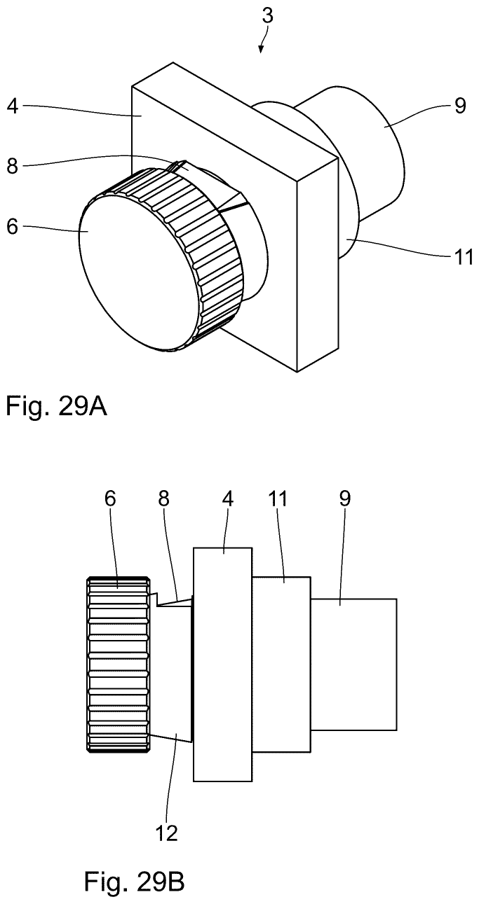

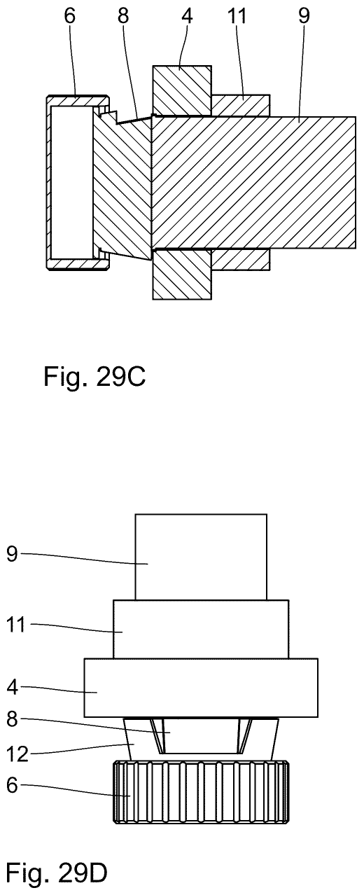

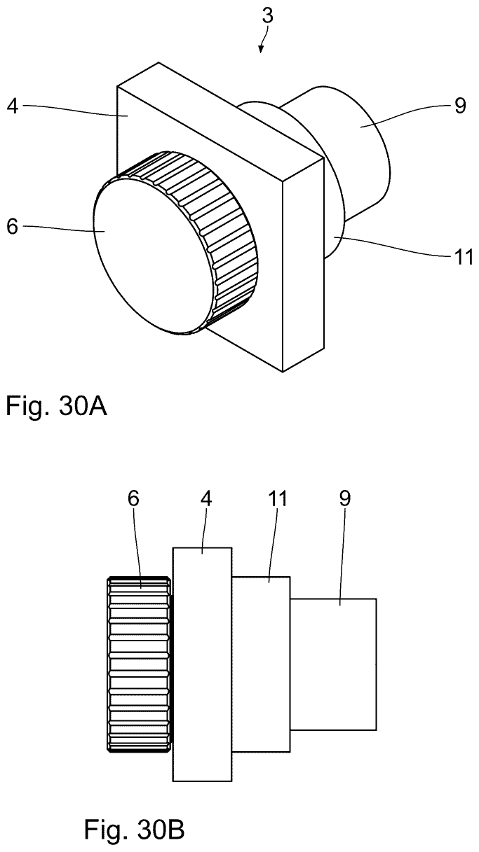

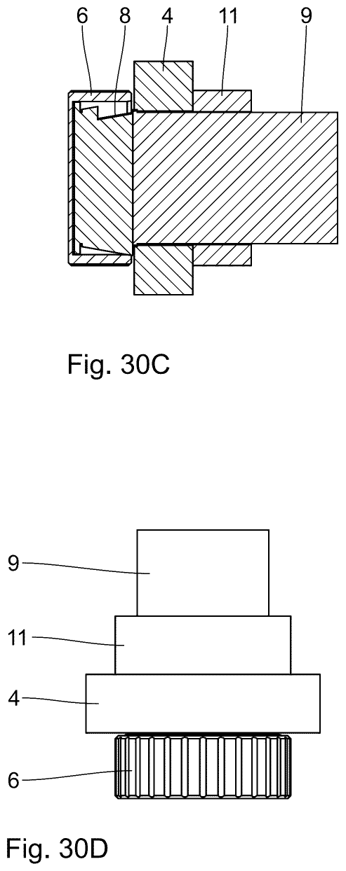

Variants are shown in FIGS. 8A and 8B, FIG. 29A to D and FIG. 30A to D, in which the display device 8 is axially diagonal and radially rectangular.

In all three variants (FIG. 6, FIGS. 7, 33 and 34 and FIGS. 8, 29 and 30), the display device 8 can be completely concealed by the operating element 6 in a frontal view.

A sectional view and a frontal view of another variant of tan operating knob 3 are shown in FIGS. 9A and 9B by way of example. In this variant, the display device 8 comprises a projection device 17. The projection device 17 comprises a light source 18. It can have a deflection element, in particular in the form of a prism 19 and/or a mirror.

The projection device 17 can have one or more imaging optical elements, in particular in the form of lenses 20 or mirrors.

The projection device 17, in particular the light source 18, can be arranged on a printed circuit board 21. The printed circuit board 21 can in particular be arranged in the receiving space 10 of the central piece 9.

The projection device 17 and in particular the display device 8, which in this case can have a projection display, are in particular integrated in tan operating knob 3, in particular in the attachment device.

A free-form surface can be used as the display surface 22 of the display device 8. This is possible in all variants and can be advantageous, in particular in terms of the arrangement and geometric configuration of the display surface 22.

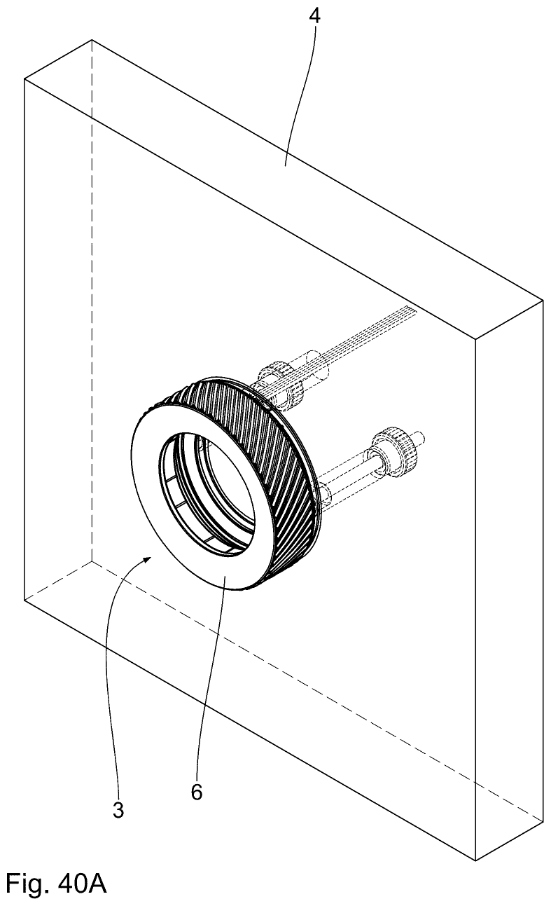

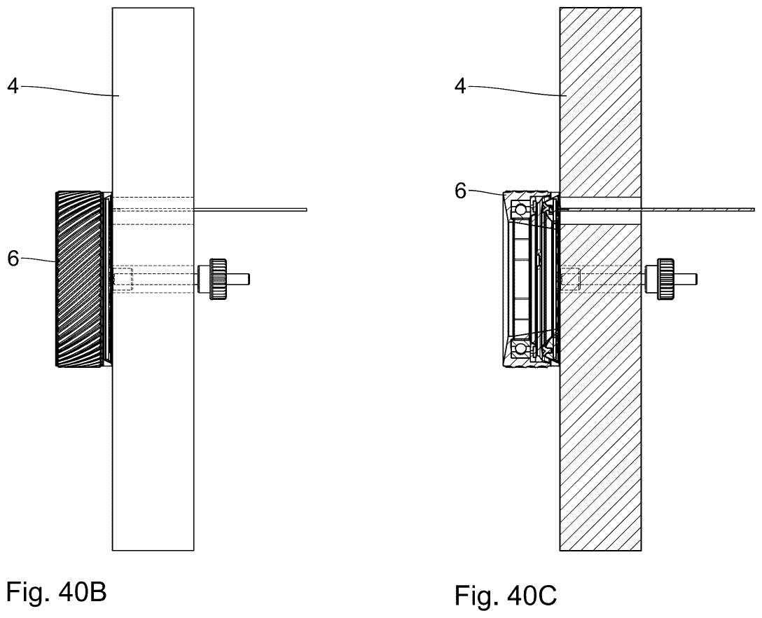

Variants of tan operating knob 3 are shown in FIGS. 10A and 10B, FIG. 40A to C, in which the operating element 6 is designed as a hollow knob. The operating element 6 is in this case in particular ring-shaped.

The variants according to FIGS. 10 and 40 differ inter alia in terms of the details of the attachment device. The details of the attachment device can substantially be combined in any manner with the other details of tan operating knob 3. For different variants and details of the attachment device, reference is made to DE 10 2024 206 141.7, which is hereby fully incorporated into the present application.

In a frontal view, the front panel 4 can be visible in the central region of the operating element 6. It is also possible that a front side of the central piece 9 is visible in the central region of tan operating knob 3 in a frontal view.

In the variant according to FIG. 10, the display device 8 can comprise the projection device 17, by means of which information can be projected onto a display surface 22 located outside relative to the operating element 6.

In the variant according to FIG. 40, the display device 8 can comprise a projection device 17, by means of which information can be projected onto a display surface 22 located inside relative to the operating element 6.

The display surface can also be integrated into the operating element 6.

Combinations are also possible.

Another variant of tan operating knob 3 is shown in FIGS. 11A and 11B. In this variant, the display device has two projection devices 17 and 23. The projection devices 17, 23 can respectively have their own light sources 18, 24. They can have fully independent, in particular separate, light paths. They can also have matching light paths in sections. The can in particular also jointly use optical components. This simplifies the structure and reduces costs.

The projection device 23 can have its own light source 24. The projection device 23 can be used for a high-quality projection into the central region of tan operating knob 3.

In the variant shown merely schematically in accordance with FIG. 12, the projection device 23 can be used for projection of the front panel of the kitchen unit.

In the variant also shown merely schematically in accordance with FIG. 13, the projection device 23 can be used for projection onto a floor region 25.

The projection device can be used, for example, to project control parameters for the household appliance, such as power levels, and/or a time and/or a data and/or a temperature indication.

This is independent of the other details of the different variants of tan operating knob 3.

Details of another variant of tan operating knob 3 are schematically shown in FIG. 14A to 14C

According to this variant, the operating element 6 can be electrically displaced. It can in particular be displaced in a motorised manner.

An extension mechanism 26 is schematically indicated in FIG. 14B.

Furthermore, a mechanical detent 27 is schematically shown in FIG. 14C.

The mechanical detent 27 enables haptic feedback.

In the variant of tan operating knob 3 shown schematically in FIG. 15, the displacement of the operating element 6 can be supported by a spiral spring 28. In general, the displacement of the operating element 6 can be supported by mechanical, magnetic or electrical means. Combinations are also possible. This is independent of the other details of the different variants of tan operating knob 3.

The travel of the operating element 6 can be guided by means of a slotted guide 29.

FIG. 17 schematically indicates that magnets 30 can be used to provide the user with haptic feedback.

In general, the operating device can have means for producing haptic feedback. Haptic feedback can be produced mechanically, for example via a toothed ring, magnetically, in particular using one or more magnets, or using a structure-borne sound converter. This is independent of the other details of the different variants of tan operating knob 3.

FIG. 18 schematically shows that the displacement of the operating element 6 can be supported by means of a lift cylinder 31.

In the variant of tan operating knob 3 according to FIG. 19, the attachment device is a hollow shaft 32. The operating element 6 is arranged on the hollow shaft 32. The operating element 6 can be designed as a ring, in particular a glass ring or plastic ring.

The operating element 6 can in particular be translucent.

The operating element 6 can be arranged so as to be displaceable on the shaft 32.

The display device 8 can be located behind the operating element 6 in an axial direction 7.

Electrical and/or electronic components, in particular printed circuit boards, can be arranged in the hollow shaft 32.

In the variant of tan operating knob 3 merely schematically shown in FIGS. 20A and 20B, the operating element 6 can be pivoted about a horizontal pivot axis 33. The operating element 6 can in particular be pivoted into a release position (FIG. 20), in which the display device 8 is exposed.

The pivot movement can be coupled with a linear movement, in particular in an axial direction 7. This can ensure that the operating element 6 does not abut against the front panel 4 when pivoted.

A tiltable variant of tan operating knob 3 can advantageously be associated with the provision of a projection device 17 and 23 (not shown). The operating element 6 can in particular serve as a light guiding element.

The operating element 6 can also have components of the projection device 17, 23, in particular optical components, in particular a mirror, a prism, a lens or a combination of corresponding components.

In the variants of tan operating knob 3 shown in FIG. 21 to 24, 36 and 38, the operating element 6 can be transparent or translucent. The operating element 6 can in particular be made of glass or a transparent or translucent plastic. It can in particular be made of clear glass or frosted glass. It can have a roughened surface.

In these variants, the operating element 6 does not need to be displaceable. It can in particular be secured in an axial direction. However, it can also be displaceable in these variants, in particular rotatable.

In the variant shown in FIGS. 21 and 22, the operating element 6 is disc-shaped.

Whilst substantially only the operating element 6 is visible in the off state (FIGS. 21A and B) in a frontal view (FIG. 21B), the display device 8 is visible in the on state (FIGS. 22A and B) in the frontal view (FIG. 22B). It can in particular be visible through the operating element 6.

This is correspondingly the case in the variant of tan operating knob 3 shown in FIGS. 23A and B and 24A and B.

In contrast to the variant shown in FIGS. 20A and B and 22A and B, the operating element 6 in the variant according to FIGS. 23A and B and 24A and B is cylindrical or bowl-shaped. It has a cylindrical circumferential surface and a cover plate. The cylindrical circumferential surface serves in particular as a gripping region.

In the variant provided in FIGS. 23 and 24, the operating device has a light device. The light device can have one or more LEDs 40. Two LEDs 40 are respectively shown by way of example in the sectional views 23A and 24A.

In addition, the operating device according to the variant in FIGS. 23 and 24 has a touch-sensitive sensor 41 (touch sensor). The touch-sensitive sensor 41 can be arranged on the circumferential side of the operating element 6.

The touch-sensitive sensor 41 can completely surround the central axis 16. Alternatively, the touch-sensitive sensor 41 can merely extend over a partial region, in particular over no more than 180°, in particular no more than 120°, in particular no more than 110°, in particular no more than 90°. It can in particular substantially correspond to the clearly visible region of the operating element 6.

Clearly visible means that the viewing angle for a user in a usual position in front of the household appliance is no more than 80°, in particular no more than 70°, in particular no more than 60°.

The operating element 6 can in particular also be arranged in a stationary manner when using a touch-sensitive sensor 41. It can in particular be arranged on the attachment device in a stationary manner. It can in particular be arranged in a stationary manner relative to the front panel 4. In this case, the touch-sensitive sensor 41 can be used for operation. Alternatively, the operating device can also have other, in particular optical and/or acoustic, sensors. Such sensors can enable gesture control and/or voice control of the household appliance.

The concept of the viewing angle EW is schematically illustrated in FIG. 25. The viewing angle EW refers to the angle between a line of sight of a user and a normal to the display device 8, in particular a local normal to the display surface 22.

A smaller viewing angle results in better visibility. In any case, it is difficult to read the display device above a viewing angle of approx. 80°.

The concept of the angle of inclination bA is schematically illustrated in FIG. 26. The angle of inclination bA refers to the angle of the front side of the display device 8 to a horizontal 36, in particular the angle between the display surface 22 and the horizontal 36.

An angle of inclination bA>0, i.e. an angled orientation of the display surface 22 of the display device 8 makes it easier to read the display, in particular from a distance in an axial direction 7.

Another variant of an operating element 6 is shown by way of example in FIGS. 41A to 41E. In this variant, the operating element 6 has a so-called “push-to-turn functionality”.

Some aspects of the push-to-turn variant are explained by way of example below:
At the start, the operating element (6) is in the initial position or starting position (FIG. 41A). This can in particular be the off position.
Starting from the initial position, the knob can be pulled out into another displacement position, in particular a menu position (FIG. 41B). Menu settings can be configured in the menu position (fan, etc.)
Starting from the initial position, the knob can be pushed into another displacement position, the initial position Push (FIG. 41C). Both the display and knob move inwards in the process.
Power level settings can be configured in the initial position Push. FIG. 41D shows a position at power level 1, by way of example.
The knob can be pulled out from the initial position Push into another menu position (FIG. 41E). Menu settings can be configured in this position without changing the power level. The display remains pushed in.

Possible menu settings include, inter alia: child lock, fan, cooking zone timer, pan detector.

1. An operating device for a household appliance, comprising:
an operating element;
a display device; and
an attachment device for attaching the operating device to a kitchen unit,
wherein the operating element has a first displacement position and at least one second displacement position, different from the first displacement position, wherein in the first displacement position, at least one first function of the household appliance is controlled or adjusted, and wherein in the at least one second displacement position, at least one second function of the household appliance, different from the at least one first function, controlled or adjusted.

2. The operating device according to claim 1, further comprising a display device which remains stationary when the operating element is actuated.

3. The operating device according to claim 1, wherein the operating element is arranged to switch the operating device between different operating levels.

4. The operating device according to claim 1, wherein a function of the household appliance is controlled or adjusted by actuating the operating element, wherein actuation is effected by:
a displacement movement of the operating element; and/or
a touch-sensitive sensor.

5. The operating device according to claim 1, wherein the operating element is arranged to be displaced in such a way that the display device is concealed in a first displacement position and the display device is exposed in a second displacement position.

6. The operating device according to claim 1, wherein the display device is arranged behind the operating element in an axial direction.

7. The operating device according to claim 1, wherein the display device is:
axially planar and radially convex;
axially diagonal and radially convex; or
axially diagonal and radially rectangular.

8. The operating device according to claim 1, wherein the operating element is ring-shaped.

9. The operating device according to claim 1, further comprising a light device with one or more light sources.

10. The operating device according to claim 1, wherein the operating element has a touch-sensitive sensor.

11. The operating device according to claim 1, further comprising a structure-borne sound converter.

12. The operating device according to claim 1, wherein the operating element is context sensitive.

13. A hob, comprising:
one or more cooking zones; and
the operating device according to claim 1.

14. A combined appliance, comprising:
a hob;
an extractor; and
an operating device with at least one operating element,
wherein the at least one operating element has a first displacement position and at least one second displacement position, different from the first displacement position, wherein in the first displacement position, the hob is controlled by the at least one operating element, and in the at least one second displacement position, the extractor is controlled by the at least one operating element.

15. An extractor with the operating device according to claim 1.
